(19) United States
(12) Patent Application Publication
(10) Pub. No.: US 2008/0033026 A1
(43) Pub. Date: Feb. 7, 2008

(54) Antimicrobial compositions, methods and systems

(76) Inventors: Jill Louise Zullo, Excelsior, MN (US); James C. Anderson, Eden Prairie, MN (US); Jayne F. Carney, Park City, UT (US); Mervyn Louis de Souza, Plymouth, MN (US); William H. Sperber, Minnetonka, MN (US); Michael J. Tupy, Crystal, MN (US); Earl H. Wagener, Pendleton, SC (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/704,866

(22) Filed: Feb. 9, 2007

Related U.S. Application Data
(60) Provisional application No. 60/772,021, filed on Feb. 9, 2006.
(60) Provisional application No. 60/851,472, filed on Oct. 13, 2006.

(51) Int. Cl. A01N 37/00; A01N 37/02; A01N 43/16; A01N 43/80; A01P 1/00

(52) U.S. Cl. 514/373; 514/372; 514/375; 514/456; 514/552; 514/557

(57) ABSTRACT

The invention provides methods for treating a surface, the method including steps of applying a surface treatment composition to a surface, wherein the surface treatment composition includes a substantially phenol-free cleansing agent and an antimicrobial agent, the antimicrobial agent comprising 9-decenoic acid, a salt of 9-decenoic acid, an ester of 9-decenoic acid, or a combination thereof, wherein the antimicrobial agent is present in an amount sufficient to control microbial growth. Also described are methods for treating a surface that include the step of applying a surface treatment composition having a pH in the range of 4.1 to 8.5 to a surface, wherein the surface treatment composition includes a cleansing agent and an antimicrobial agent, the antimicrobial agent comprising 9-decenoic acid, a salt of 9-decenoic acid, an ester of 9-decenoic acid, or a combination thereof, wherein the antimicrobial agent is present in an amount sufficient to control microbial growth. Also described are surface treatment compositions including the antimicrobial agents.

### CROSS-REFERENCE TO RELATED APPLICATIONS

The present Application claims the benefit of commonly owned provisional Application having Ser. No. 60/772,021, filed on Feb. 9, 2006, and entitled ANTIMICROBIAL COMPOSITIONS, METHODS AND SYSTEMS; and provisional Application having Ser. No. 60/851,472, filed Oct. 13, 2006, and entitled ANTIMICROBIAL COMPOSITIONS, METHODS AND SYSTEMS.

### FIELD OF THE INVENTION

The invention relates to antimicrobial compositions, methods and systems. More particularly, the invention relates to compositions useful as disinfectants and also useful as preservatives in cleansing agent formulations for household, industrial and personal care use.

### BACKGROUND OF THE INVENTION

It is generally acknowledged that water-containing products, including many cleansing agents (for household or institutional use), can support the proliferation of microorganisms. Without sufficient preservation, this in turn can lead to product spoilage, which may be manifest in the products as changes in smell, discoloration, mould growth, gas formation, separation of emulsions or changes in viscosity, thereby rendering the product unacceptable to a consumer. Moreover, non-visible microbial contamination can also present a significant danger, posing a risk to consumer health should the microorganisms be potentially pathogenic.

The designation of a microorganism as objectionable for a particular category of non-sterile products depends upon its established pathogenic potential and ability to cause infections or diseases via the application route (which in turn is determined by the intended use of the product). Many cleansing agents and disinfectants come into contact with the skin and can also contact the mucous membranes of the eye, nasal cavity and buccal cavity. Moreover, if the user has any cutaneous lesions, such compromised areas of the skin can present opportunity for microorganisms to cross the skin barrier.

Some relevant microbial pathogens include: Gram-positive bacteria (such as Staphylococcus aureus, Streptococcus pyogenes, Enterococcus spp., Clostridium tetani, Listeria monocytogenes and Clostridium perfringens), Gram-negative bacteria (such as Pseudomonas spp., Klebsiella spp., Salmonella spp. and Enterobacteriaceae), and fungi (such as Candida albicans, Candida parapsilosis, Malassezia furfur, Trichophyton spp., Trichoderma, and Aspergillus spp.). Classic skin pathogens include bacteria such as Staphylococcus aureus, various Pseudomonas spp., and fungus such as Candida albicans.

Microbial spoilage of a product can occur as a result of contamination during manufacture of the product, or during use by the consumer. For example, the surface area of an open container of cleansing agent that is open to the atmosphere and in repeated contact with the more or less heavily contaminated hand of the user, presents a scenario highly favorable to post-production microbial contamination.

A product formulation's preservative properties influence microorganism metabolic activity, and when effective can halt metabolism, in other words, effect bacteriostasis or fungistasis, or even effect death of the microorganism.

Apart from any preservative function, some cleansing agents can be formulated to provide disinfectant function. Generally speaking, disinfectants are compositions that destroy vegetative forms of microorganisms, especially on inanimate objects. For adequate disinfection, pathogens are killed but some organisms and bacterial spores may survive. Disinfectants typically vary in their tissue-damaging properties from the corrosive phenol-containing compounds (which should be used only on inanimate objects), to less toxic materials such as ethanol and iodine (which can be used on skin surfaces).

Death of microorganisms occurs at a certain rate dependent primarily upon two variables: the concentration of the killing agent and the length of time it is applied. The rate of killing is defined by the relationship
Nα1/CT
which shows that the number of survivors, N, is inversely proportionate to the concentration of the agent, C, and the time of application of the agent, T. Collectively, CT is often referred to as the dose. Stated alternatively, the number of microorganisms killed is directly proportionate to CT. The relationship is usually stated in terms of survivors, as they are easily measured by colony formation. Microbial death is defined as the inability to reproduce.

Many disinfectants pose risk to humans during use, as a result of tissue-damaging properties mentioned above. For example, disinfectants containing phenols, chlorine, and other powerful agents can pose risk of damaging skin and mucosal tissue of a consumer during use of the products. Potential toxicity to humans can restrict the types of disinfectants available for use by consumers, and/or the applications for which they can be used.

### SUMMARY OF THE INVENTION

According to the invention, it has been found that 9-decenoic acid, salts of 9-decenoic acid, and esters of 9-decenoic acid are useful as antimicrobial agents in a variety of industrial and commercial applications, including applications in cleansing agents, disinfectants, and in textile applications. While some antimicrobial activity of 9-decenoic acid, certain salts of 9-decenoic acid, and certain esters of 9-decenoic acid have been previously reported, the present application describes novel uses, compositions and systems that include these compounds.

According to the invention, it has been found that 9-decenoic acid, salts of 9-decenoic acid, and esters of 9-decenoic acid are useful in controlling microbial growth. As discussed herein, control of microbial growth can involve preventing propagation of microbes within an environment, and/or elimination of many or all pathogenic microorganisms in an environment.

For instance, 9-decenoic acid, salts of 9-decenoic acid, and esters of 9-decenoic acid can be incorporated into surface treatment compositions to protect the compositions themselves from microbial attack (i.e., as preservatives). In these embodiments, 9-decenoic acid, salts of 9-decenoic acid, and esters of 9-decenoic acid can be utilized as an auxiliary agent within the surface treatment composition to be preserved and/or protected from microbial attack and/or spoilage.

Furthermore, 9-decenoic acid, salts of 9-decenoic acid, and esters of 9-decenoic acid can be employed as a disinfectant. In these embodiments, 9-decenoic acid, salts of 9-decenoic acid, and esters of 9-decenoic acid can be incorporated as an active ingredient in a variety of surface treatment compositions for household and industrial use. In some aspects, the 9-decenoic acid, salt of 9-decenoic acid, or ester of 9-decenoic acid is present in an amount sufficient to provide a surface treatment composition with disinfectant properties. As used herein, the term “disinfect” shall mean the elimination of many or all undesirable (e.g., pathogenic) microorganisms in an environment (e.g., a surface) with the possible exception of bacterial endospores. As used herein, the term “sanitize” shall mean the reduction of contaminants in the inanimate environment to levels considered safe according to public health ordinance, or that reduces the bacterial population by significant numbers where public health requirements have not been established. An at least 99% reduction in bacterial population within a 24 hour time period is deemed “significant.”

It has been found that 9-decenoic acid, salts of 9-decenoic acid, and esters of 9-decenoic acid possess significant antimicrobial activity against a broad spectrum of microorganisms. Moreover, these antimicrobial compounds possess low toxicity and can be utilized to provide more mild end products. Further, in some aspects, quick kill times for a variety of microorganisms are observed when these compounds are provided to a treatment environment, such as a hard surface. Still further, these compounds can be easily formulated with other components to provide end products that in turn will possess antimicrobial properties.

Given the properties of 9-decenoic acid, salts of 9-decenoic acid, and esters of 9-decenoic acid, as described herein, these compounds can be used as auxiliary agents to provide preservatives, or as disinfectants. Generally speaking, when the compounds are utilized as an auxiliary agent within a product formulation (e.g., surface treatment composition), the compounds are combined with components typically found in the product formulation. Taking personal care products as an example, the compounds can be combined with such typical personal care ingredients as surfactants, emollients, and the like. When the compounds are utilized as an active agent, the compounds can be combined with a solvent to reach a desired concentration of the antimicrobial agent in the solvent, thereby providing a disinfectant composition. Likewise, the compounds can be combined with components typically found in consumer products (such as detergents or soaps), to thereby provide “antimicrobial” products that disinfect or sanitize.

Another distinction between the preservatives and disinfectants of the invention can, in some aspects, be found in the concentration of antimicrobial agent in the end product. Typically (but not necessarily), a lower concentration of antimicrobial agent can be utilized as a preservative, as compared to a disinfectant, where the objective is to kill microorganisms in a relatively short amount of time.

In some aspects, the invention provides methods and systems for formulating surface treatment composition comprising combining one or more antimicrobial agents described herein with other ingredients of a cleansing agent to control growth of microorganisms within the surface treatment composition over time. In these aspects, microorganisms can be introduced into the surface treatment composition during manufacture and/or by the consumer during use of the surface treatment composition. Thus, the invention can provide methods for controlling growth of microorganisms in surface treatment compositions by combining an antimicrobially effective amount of one or more antimicrobial agents with other ingredients typically found in the surface treatment composition. In accordance with these embodiments, the antimicrobial agents are utilized as an auxiliary agent to provide preservative function to consumer products, such as surface treatment compositions.

In other aspects, the invention provides methods and systems for formulating disinfectants. The disinfectant aspects of the invention are due, at least in part, to one or more of the following features of the antimicrobial agents described herein: relatively quick kill of microorganisms, broad-spectrum biocidal function, and low concentration required for biocidal effect.

In some aspects, the invention provides methods of treating an environment suspected to contain undesirable microorganisms, the method comprising exposing the environment to a biocidally effective amount of an antimicrobial agent. In some embodiments, the biocidally effective amount is an amount of antimicrobial agent sufficient to eliminate virtually all selected microorganisms suspected to be present in a selected environment. In some aspects, this amount can be an amount sufficient to cause a 5-log reduction in selected microorganisms. In some embodiments, the biocidally effective amount is an amount sufficient to eliminate virtually all selected microorganisms within a desired amount of time, for example, in two minutes or less, or one minute or less, or 30 seconds or less. In some aspects, the biocidally effective amount is an amount sufficient to cause a 5-log reduction in E. coli and/or S. aureus in 30 seconds or less in a sample, if present. The concentration of antimicrobial agent can depend upon the particular agent selected, the application (for example, industrial or household application, hard surface or textile application, and the like), and other like factors.

In some aspects, the invention provides a method of treating a surface, the method comprising applying a surface treatment composition to a surface, wherein the surface treatment composition includes a substantially phenol-free cleansing agent and an antimicrobial agent, the antimicrobial agent comprising 9-decenoic acid, a salt of 9-decenoic acid, an ester of 9-decenoic acid, or a combination thereof, wherein the antimicrobial agent is present in an amount sufficient to control microbial growth.

In further method aspects, the invention provides a method of treating a surface, the method comprising applying a surface treatment composition having a pH in the range of 4.1 to 8.5 to a surface, wherein the surface treatment composition includes a cleansing agent and an antimicrobial agent, the antimicrobial agent comprising 9-decenoic acid, a salt of 9-decenoic acid, an ester of 9-decenoic acid, or a combination thereof, wherein the antimicrobial agent is present in an amount sufficient to control microbial growth.

In some embodiments, the surface treatment composition has a pH in the range of 6 to 8.

In some aspects, the antimicrobial agent is present in an amount sufficient to provide the surface treatment composition with antimicrobial properties to resist spoilage, for example, the antimicrobial agent can be present in an amount in the range of 0.002% to 3% by weight, based on total weight of the surface treatment composition.

In some aspects, the antimicrobial agent is present in an amount sufficient to provide the surface treatment composition with disinfectant properties at the surface. In some embodiments, the antimicrobial agent is present in an amount sufficient to cause a 5-log reduction in one or more target microorganisms at the surface in a time period of 1 minute or less. Illustrative target microorganisms include Staphylococci spp., pseudomonads, Klebsiella spp., and coliforms. In some embodiments, the antimicrobial agent is present in an amount of 0.125% by weight or less, based on total weight of the surface treatment composition.

Optionally, the surface treatment composition can further include a second antimicrobial agent. In some embodiments, the surface treatment composition can include water as a solvent.

In some compositional aspects, the invention provides a surface treatment composition comprising a substantially phenol-free cleansing agent and an antimicrobial agent, the antimicrobial agent comprising 9-decenoic acid, a salt of 9-decenoic acid, an ester of 9-decenoic acid, or a combination thereof, wherein the antimicrobial agent is present in an amount sufficient to control microbial growth.

In still further compositional aspects, the invention provides a surface treatment composition having a pH in the range of 4.1 to 8.5, wherein the surface treatment composition includes a cleansing agent and an antimicrobial agent, the antimicrobial agent comprising 9-decenoic acid, a salt of 9-decenoic acid, an ester of 9-decenoic acid, or a combination thereof, wherein the antimicrobial agent is present in an amount sufficient to control microbial growth.

In some embodiments, the antimicrobial agent is 9-decenoic acid having the structure shown in Formula I: 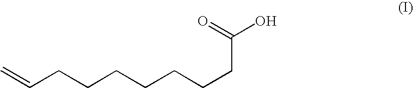
9-decenoic acid has been found to be particularly effective at providing antimicrobial properties to cleaning agents as described herein. When formulated with other ingredients typically found in these products, the end product exhibits improved shelf stability. 9-decenoic acid has also been found to be an effective disinfectant, causing a 5-log reduction in various microorganisms at low concentrations in short amounts of time. In addition, 9-decenoic acid exhibits low toxicity to humans and broad-spectrum activity against microorganisms.

In some embodiments, the antimicrobial agent is an ester of 9-decenoic acid having the structure shown in Formula II: 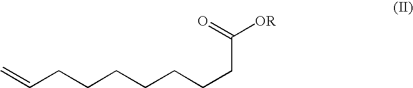
where —R is an organic group. As used herein, “organic group” can be an aliphatic group, an alicyclic group, or an aromatic group. Organic groups can include heteroatoms (such as O, N, or S atoms), as well as functional groups (such as carbonyl groups). In the context of the invention, the term “aliphatic group” means a saturated or unsaturated, linear or branched, hydrocarbon group. This term is used to encompass alkyl, alkenyl, and alkynyl groups, for example. The term “alkyl group” means a monovalent, saturated, linear or branched, hydrocarbon group. The term “alkenyl group” means a monovalent, saturated, linear or branched, hydrocarbon group with one or more carbon-carbon double bonds. The term “alkynyl group” means a monovalent, unsaturated, linear or branched, hydrocarbon group with one or more carbon-carbon triple bonds. An alicyclic group is an aliphatic group arranged in one or more closed ring structures. The term is used to encompass saturated (such as cycloparaffins) or unsaturated (cycloolefins or cycloacetylenes) groups. An aromatic group or aryl group is an unsaturated cyclic hydrocarbon having a conjugated ring structure. Included within aromatic or aryl groups are those possessing both an aromatic ring structure and an aliphatic group or an alicyclic group. In some aspects, —R can be selected to serve a dual role as an antimicrobial agent and emulsifier or compatibility aid. For example, embodiments where —R is a C₈ to C₁₆ alkyl group may provide emulsification properties.

In some embodiments, —R is an alkyl group, for example, a C₁ to C₁₈ alkyl group, a C₂ to C₁₈ alkyl group, a C₁ to C₆ alkyl group, or a C₂ to C₆ alkyl group. Representative examples include methyl, ethyl, propyl (n-propyl or i-propyl) butyl (n-butyl or t-butyl), heptyl, octyl, nonyl, decyl, dodecyl, octadecyl, and the like. In other embodiments, —R is an alkenyl group, for example, a C₉ alkenyl group, such as, —CH₂—CH₂—CH₂—CH₂—CH₂—CH₂—CH₂—CH₂═CH₂. In some aspects, the esters of 9-decenoic acid can be particularly useful, as these compounds can be pH independent within certain formulations.

In some embodiments of the invention, the antimicrobial agent is a salt of 9-decenoic acid having the structure shown in Formula (III):
K⁺ⁿ[R⁻]ₙ (III)
where R⁻ is 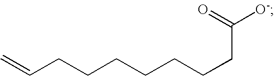
n is an integer, for example, ranging from 1 to 4; and
K⁺ⁿ is a +n charged cation.

When n=1, representative examples include group IA cations (such as Li⁺, Na⁺, K⁺, and Ag⁺), and a variety of ammonium salts, such as those including ammonium (NH₄⁺) or quaternary ammonium (NR₄⁺) as cations. When n=2, representative examples include Ca²⁺, Mg²⁺, Zn²⁺, Cu²⁺, and Fe²⁺. When n=3, representative examples include Al³⁺, Fe³⁺ and Ce³⁺. When n=4, representative examples include Ce⁴⁺. In still further embodiments, the anion/cation pair (K⁺ⁿ[R⁻]ₙ) can bind a known antimicrobial agent, such as those described elsewhere herein as useful for the second antimicrobial agent. In some embodiments, the anion/cation pair can serve a dual role, such as, for example, as antimicrobial agent and emulsifier or compatibility aid (for example, the copper salt may enhance activity against algal species, while the zinc salt may enhance anti-fungal activity).

In other aspects, the invention provides novel antimicrobial compositions for controlling microbial growth in a wide range of products (preservatives) and/or to eliminate microorganisms in an environment (disinfectants). These novel antimicrobial compositions can comprise a combination of any two or more of the antimicrobial agents of Formula (I), (II) or (III).

In still further aspects, the invention provides novel antimicrobial compositions for controlling microbial growth in a wide range of products and/or eliminating microorganisms in an environment, the antimicrobial compositions comprising any one or more of the antimicrobial agents of Formula (I), (II), and/or (III), in combination with one or more known antimicrobial agents (second antimicrobial agent). In some aspects, the second antimicrobial agent is substantially phenol-free. In some aspects, the overall surface treatment composition has a pH in the range of 4.1 to 8.5, or 5 to 8.5, or 6-8. In these combination aspects, the invention can provide commercial products with significantly lower toxicity than current products that include the second antimicrobial agent(s) alone. In this discussion, the term “toxicity” is used in its broadest sense. It may mean toxicity to people per se, harm or damage to the environment, indirect harm to people via environmental damage, and/or simply tissue (e.g., skin or mucous membrane) irritation. In other words, the antimicrobial agents of Formula (I), (II) and/or (III) can replace at least a portion of the second antimicrobial agent, thus providing lower toxicity of the overall product. It is known that products such as Kathon™, Triclosan™ and others can have toxicity effects in current formulations. Thus, by replacing at least a portion of these substances with the antimicrobial agent of Formula (I), (II), and/or (III), an end product with lower overall toxicity can be achieved. In some aspects, this lower toxicity can be accomplished while maintaining efficacy of the antimicrobial agents as a whole.

The antimicrobial features of the invention are described herein with reference to the minimum inhibitory concentration (MIC) and the minimum bactericidal concentration (MBC) of the agent. As described herein, the MIC is defined as the concentration of the antimicrobial agent that completely inhibited growth of a challenge organism. The MBC is defined as the concentration of antimicrobial agent that completely eradicated viable organisms from the test system. Thus, for preservative features of the inventive methods and systems, the MIC will be discussed with particularity. With respect to the disinfectant features of the inventive methods and systems, the MBC will be discussed with particularity.

It has been surprisingly discovered that the inventive methods and systems utilizing the antimicrobial agents described herein demonstrate a broad antimicrobial activity spectrum that embraces Gram-positive and Gram-negative bacteria, as well as fungi. These antimicrobial agents can, in some aspects, provide special value in a broad range of industrial applications due to their low oral, skin, eye, and aquatic toxicity as well as low irritation properties. This ability to deliver efficacious antimicrobial activity while providing low toxicity and irritation properties can be particularly valuable in applications such as cleansing agents and disinfectants (such as detergents and hard surface cleansers, where toxicity and environmental effects are a concern). Further advantageous features that can be present include relatively quick biocidal action, efficacy against microorganisms that are typically difficult to control, and ease of formulation with other ingredients.

In some aspects, the broad-spectrum activity of the antimicrobial agents described herein can also provide enhanced activity as a preservative or disinfectant by reducing the likelihood of formation of biofilms. As discussed herein, some antimicrobial agents of the invention have shown efficacy against pseudomonads, organisms that can cause biofilms. Generally speaking, once a biofilm has formed, the bacteria of the biofilm are highly resistant to disinfection and removal from the surface. Thus, the formation of biofilms can present significant challenges for treatment of surfaces with antimicrobial agents.

These and other aspects and advantages will now be described in more detail.

### BRIEF DESCRIPTION OF THE FIGURES

FIG. 1 is a figure showing exemplary ruthenium-based metathesis catalysts.

FIG. 2 is a figure showing exemplary ruthenium-based metathesis catalysts.

FIG. 3 is a figure showing exemplary ruthenium-based metathesis catalysts.

FIG. 4 is a figure showing exemplary ruthenium-based metathesis catalysts.

### DETAILED DESCRIPTION OF THE INVENTION

The embodiments of the invention described below are not intended to be exhaustive or to limit the invention to the precise forms disclosed in the following detailed description. Rather, the embodiments are chosen and described so that others skilled in the art can appreciate and understand the principles and practices of the invention.

Throughout the specification and claims, percentages are by weight and temperatures in degrees Celsius unless otherwise indicated.

Novel uses of 9-decenoic acid, salts of 9-decenoic acid, and esters of 9-decenoic acid have been discovered. In some aspects, 9-decenoic acid, salts of 9-decenoic acid, and esters of 9-decenoic acid can be used as antimicrobial agents alone, i.e., without additional antimicrobial agents. In accordance with these aspects of the invention, 9-decenoic acid, salts of 9-decenoic acid, and esters of 9-decenoic acid can function at low concentrations alone (i.e., without additional antimicrobial agents) with the desired efficacy. In some embodiments, antimicrobial compositions consist essentially of 9-decenoic acid, one or more salts of 9-decenoic acid, and/or one or more esters of 9-decenoic acid. In some embodiments, these antimicrobial agents can be utilized in compositions that are “substantially phenol-free,” as described herein. In some embodiments, these antimicrobial agents can be utilized in compositions that do not include known antimicrobial agents such as short-chain alcohols (such as C₁₋₄ alcohols such as ethanol or propanol); phenolic compounds having anti-oxidant properties (such as butylated hydroxy toluene (BHT), butylated hydroxy anisol (BHA), tertiary butyl hydroxy quinone (TBHQ)) and natural analogues with similar anti-oxidant properties such as tocopherols, cinnamic acid compounds and compounds generally described as flavins or flavinoids; and/or short chain water soluble organic acids having carbon chain length 1-4 (such as formic, acetic, propionic, butyric acid, including substituted and branched chain acids such as lactic acid, glycolic acid, alanine, cystein, malonic, succinic, glataric acid).

In addition, novel compositions that include 9-decenoic acid, salts of 9-decenoic acid, and esters of 9-decenoic acid are described herein, the compositions including combinations of two or more of these compounds. Further, novel compositions that include 9-decenoic acid, salts of 9-decenoic acid, and/or esters of 9-decenoic acid in combination with one or more second (different) antimicrobial agents are described. In accordance with this latter aspect of the invention, the second antimicrobial agent can be a known antimicrobial agent, and often can comprise an antimicrobial agent that possesses higher toxicity than the compounds that are the subject of this invention.

As will be apparent upon review of this disclosure, the antimicrobial agents can be formulated to provide a variety of antimicrobial compositions as end products. The antimicrobial compositions can be in concentrated form or from a container, from an aerosol container, or from a container as a crystal, powdered or otherwise semi-solid or solid form, or as a liquid. The antimicrobial compositions can be applied in various formulations such as, but not limited to, solutions, gels, creams, lotions, sticks, balms, sprays, powders and the like in either aqueous or nonaqueous vehicles.

Antimicrobial Agent

It has been discovered that 9-decenoic acid, salts of 9-decenoic acid, and esters of 9-decenoic acid have unexpected, much broader antimicrobial activity than previously described. Under standard microbial tests, these agents have been found to inhibit the growth of and/or eliminate various Gram-positive bacteria (such as Staphylococcus aureus, Streptococcus pyogenes, Enterococcus spp., Clostridium tetani, Listeria monocytogenes, Clostridium perfringens, Bacillus spp., Pediococcus spp., and Lactobacillus spp), Gram-negative bacteria (such as Pseudomonas spp., Klebsiella spp., Salmonella spp., Enterobacteriaceae, and Serratia spp.), and fungi (such as Candida albicans, Candida parapsilosis, Malassezia furfur, Trichophyton spp., Trichoderma, Aspergillus spp., and Cladosporium spp.). In addition, these agents can, in some embodiments, inhibit the growth of and/or eliminate various coliforms. Illustrative coliforms include E. coli, Enterobacter and Klebsiella.

It has been discovered that 9-decenoic acid, salts of 9-decenoic acid, and esters of 9-decenoic acid can be effective in controlling microbial growth within various cleansing agents (i.e., as a preservative) and effective at eliminating microorganisms in an environment (i.e., as a disinfectant).

In one compositional aspect, the antimicrobial agent can be a monounsaturated fatty acid of 10 carbon atoms that can be provided as an acid, salt, or ester. In some embodiments, the antimicrobial agent is 9-decenoic acid having the structure shown in Formula I: 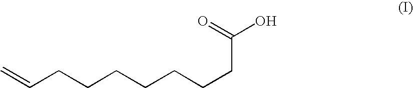
9-decenoic acid (also known as caproleic acid) has been found to be particularly effective at providing antimicrobial properties as preservatives and/or sanitizers or disinfectants. When formulated with other ingredients found in various consumer and/or industrial products, the end product exhibits improved antimicrobial activity. In addition, 9-decenoic acid exhibits low toxicity to humans and broad-spectrum activity against microorganisms.

Generally, 9-decenoic acid is a colorless liquid having a molecular weight of approximately 170, boiling point of approximately 269° C. to 271° C./760 mm, specific gravity of 0.912 to 0.920 at 25° C., and refractive index of 1.44 to 1.45 at 20° C. Generally, 9-decenoic acid is soluble in water at biocidal levels (as described elsewhere herein), and soluble in alcohol.

In some embodiments, the antimicrobial agent can be an ester of 9-decenocid acid having the structure shown in Formula II: 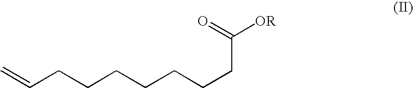
where —R is an organic group. As used herein, “organic group” can be an aliphatic group, an alicyclic group, or an aromatic group. Organic groups can include heteroatoms (such as O, N, or S atoms), as well as functional groups (such as carbonyl groups). In the context of the invention, the term “aliphatic group” means a saturated or unsaturated, linear or branched, hydrocarbon group. This term is used to encompass alkyl, alkenyl, and alkynyl groups, for example. The term “alkyl group” means a monovalent, saturated, linear or branched, hydrocarbon group. The term “alkenyl group” means a monovalent, saturated, linear or branched, hydrocarbon group with one or more carbon-carbon double bonds. The term “alkynyl group” means a monovalent, unsaturated, linear or branched, hydrocarbon group with one or more carbon-carbon triple bonds. An alicyclic group is an aliphatic group arranged in one or more closed ring structures. The term is used to encompass saturated (such as cycloparaffins) or unsaturated (cycloolefins or cycloacetylenes) groups. An aromatic group or aryl group is an unsaturated cyclic hydrocarbon having a conjugated ring structure. Included within aromatic or aryl groups are those possessing both an aromatic ring structure and an aliphatic group or an alicyclic group.

In some aspects, —R may be selected to serve a dual role as an antimicrobial agent and emulsifier or compatibility aid. For purposes of emulsifying immiscible phases or stabilizing an emulsion, the addition of an amphiphilic molecule may enhance interfacial contact. Amphiphilic molecules are molecules that have regions of two distinct polarities. One part of the molecule is polar, or hydrophilic, which makes it attracted to the more polar phase. The other part of the molecule is non-polar, or hydrophobic, making it attracted to the non-polar phase. The dual nature of these molecules draws them to the interface between two immiscible phases where they adsorb and lower the energy of the phase boundary. Molecules that adsorb strongly and provide high interfacial loadings are typically good surfactants, and may be good emulsifiers. The strength of attraction for a surfactant to the interface, or absorption energy, is dependent in part on the strength of interaction for each part of the amphiphile to each phase. So a strongly adsorbing surfactant will, generally speaking, have a polar hydrophilic component attracted to polar phase and a very nonpolar hydrophobic component strongly attracted to the nonpolar phase. A feature of each component of the amphiphile is that it preferably must retain sufficient solubility as a whole molecule in one of the phases so that the surfactant can be delivered to the interface. Interfacial tension is reduced by adsorption of surfactant molecules and is a colligative property, meaning that interfacial tension reduction is dependent primarily on the number of molecules adsorbed. Appropriate selection of the hydrophilic and hydrophilic species in the emulsifier determines its performance.

For the case of linear alkyl groups used as the hydrophobic moiety, the chain length is a variable that may be used to tailor emulsification properties. Chains that are too short typically do not provide enough attraction to the nonpolar phase to make a strongly adsorbing amphiphile. Chains that are too long bring greater steric hindrance to the interface and may prevent other molecules from adsorbing thus reducing the interfacial loading and tension reduction. Long alkyl chains can also have reduced solubility in one of the phases. Embodiments where —R is a C₈ to C₁₆ alkyl group may provide emulsification properties in certain surface coating compositions. In some embodiments, —R is a C₁₀ to C₁₂ alkyl group. The selection of the appropriate alkyl group may depend, for example, on the rest of the molecule to which the alkyl group is attached and may also depend on the composition of the phases with which the molecule interacts.

In some embodiments, —R is an alkyl group, for example, a C₁ to C₁₈ alkyl group or a C₁ to C₆ alkyl group. Representative examples include methyl, ethyl, propyl (n-propyl or i-propyl) butyl (n-butyl or t-butyl), heptyl, octyl, nonyl, decyl, dodecyl, octadecyl, and the like. In other embodiments, —R is an alkenyl group, for example, a C9 alkenyl group, such as, —CH₂—CH₂—CH₂—CH₂—CH₂—CH₂—CH₂—CH₂═CH₂.

In still further embodiments, —R can comprise a known antimicrobial agent, such as (but not limited to) antimicrobial agents described elsewhere herein as useful as second antimicrobial agents.

In some aspects, utilization of a 9-decenoic acid ester, as described in Formula (II), can be advantageous, as these compounds can be pH independent in various formulations.

In some embodiments of the invention, the antimicrobial agent is a salt of 9-decenoic acid having the structure shown in Formula (III):
K⁺ⁿ[R⁻]ₙ (III)
where R⁻ is 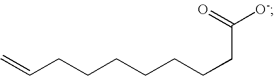
n is an integer, for example, ranging from 1 to 4; and
K⁺ⁿ is a +n charged cation.

When n=1, representative examples include group IA cations (such as Li⁺, Na⁺, K⁺, and Ag⁺), and a variety of ammonium salts, such as those including ammonium (NH₄⁺) or quaternary ammonium (NR₄⁺) as cations. When n=2, representative examples include Ca²⁺, Mg²⁺, Zn²⁺, Cu²⁺, and Fe²⁺. When n=3, representative examples include Al³⁺, Fe³⁺ and Ce³⁺. When n=4, representative examples include Ce⁴⁺. In still further embodiments, the anion/cation pair (K⁺ⁿ[R⁻]ₙ) can bind a known antimicrobial agent, such as those described elsewhere herein as useful for the second antimicrobial agent. In some embodiments, the anion/cation pair can serve a dual role, such as, for example, as antimicrobial agent and emulsifier or compatibility aid.

In some aspects, utilization of a salt of 9-decenoic acid, as described in Formula (III) can be advantageous, for example, by being more soluble in aqueous systems, less volatile, and/or easier to handle as compared to the acid or ester forms of 9-decenoic acid. The choice of an antimicrobial agent from Formulae (I), (II) and/or (III) will depend upon the end use of the composition, including formulation considerations, target microorganisms, and the like.

It will be readily appreciated that some combination of 9-decenoic acid and salt can occur within a composition by virtue of the pH level of the composition. For example, at calculated pKa of about 4.78 (±0.1), a composition will be composed of approximately equal amounts of 9-decenoic acid and salt (50/50 9-deceonic acid/salt). In some embodiments, presence of 9-decenoic acid (at some levels in the composition) can be particularly advantageous.

For the antimicrobial agents of Formulae I-III, the solubility in an aqueous and an alcohol environment was studied. Solubility studies were carried out with the sodium (Na) and potassium (K) salts of 9-decenoic acid in water and isopropanol (IPA). Six samples were analyzed. The samples were as follows: Na salt in water, Na salt in IPA, K salt in water, K salt in IPA, 9-decenoic acid (protonated) in water, 9-decenoic acid (protonated) in IPA. For the protonated form of the acids, the samples were acidified and diluted in IPA and subjected to analysis by gas chromatography/flame ionization detector (GC/FID). The same procedure was followed for the Na and K salts in IPA. For the Na and K salts in water, the samples were acidified and then extracted with petroleum ether. The petroleum ether was then evaporated, and the samples were reconstituted in IPA, acidified and subjected to analysis by GC/FID. Concentrations were calculated by comparing the peak area of the sample to a calibration table of 9-decenoic acid. The calibration curve was linear from 1 mg/g to 500 mg/g. The solubility results of the six samples are shown in Table 1. Results are reported in mg/g (mg 9-decenoic acid/g solvent).

TABLE 1
Solubility of 9-decenoic acid and salts.

| | Concentration |
|---|---|
| Sample | (mg/g) |
| 9-decenoic acid (protonated) in water | <1 |
| 9-decenoic acid (protonated) in isopropanol | 493 |
| sodium salt in water | 260 |
| sodium salt in isopropanol | 1 |
| potassium salt in water | 240 |
| potassium salt in isopropanol | 10 |

From the data in Table 1, it is clear that the salt form of 9-decenoic acid is much more soluble in water than in isopropanol. Conversely, the protonated form of the acid is more soluble in isopropanol than water.

The ability to control solubility of the antimicrobial agent by providing a salt form (thereby providing a water-soluble agent) or the acid form (thereby providing an agent more soluble in nonaqueous compositions) can provide beneficial features in the inventive methods and systems. For example, when it is desired to provide a water-based antimicrobial agent or disinfectant, the salt forms of the agent can be utilized. Alternatively, when it is desired to provide an antimicrobial agent that is soluble in nonaqueous systems, the acid form can be utilized. The relative solubility and the antimicrobially effective amount required for a particular microorganism (or class of microorganisms) can be taken into account when formulating an antimicrobial composition including one or more of the agents as preservatives described herein. Similarly, the relative solubility and the biocidally effective amount can be taken into account when formulating biocidal compositions including one or more antimicrobial agents as disinfectants.

Generally speaking, for many cleansing agent applications (and in particular, in many personal care applications), it can be desirable to utilize a water soluble antimicrobial agent, while applications such as textiles and solid surfaces (such as cutting boards for food applications) can benefit from utilization of a less soluble antimicrobial agent.

In some aspects, the invention contemplates use of antimicrobial compositions composed of the agents of Formulae (I), (II) and/or (III) alone. In these aspects, no additional agent that possesses significant antimicrobial properties is included in the composition. In some embodiments, these antimicrobial compositions do not include known antimicrobial agents such as short-chain alcohols (such as C₁₋₄ alcohols); phenolic compounds having anti-oxidant properties and natural analogues with similar anti-oxidant properties such as tocopherols, cinnamic acid compounds and compounds generally described as flavins or flavinoids; and/or short chain water soluble organic acids having carbon chain length 1-4, as discussed herein.

In accordance with some aspects of the invention, the antimicrobial agents of Formulae (I), (II) and/or (III) can be utilized in compositions having a wide variety of pH levels. In particular, the esters of 9-decenoic acid as illustrated in Formula (II), can be pH independent in various formulations. In other words, esters of 9-decenoic acid, as illustrated in Formula II, can be effective at various pH levels. This is in contrast to many known antimicrobial agents, such as organic acids, that can possess significantly higher antimicrobial effect at lower (acidic) pH levels. In some embodiments, the pH level of surface treatment compositions including the antimicrobial agents in accordance with the invention can be approximately neutral to acidic, for example pH of 8 or less, or 7 or less, or 6 or less, or 5 or less. In some aspects, the surface treatment compositions can have a pH of 4.1 to 8.5, or 4.5 to 8, or 5 to 8, or 6 to 8. These pH levels can be useful for compositions composed of 9-decenoic acid, in particular.

In further aspects, surface treatment compositions in accordance with principles of the invention can include a substantially phenol-free cleansing agent and an antimicrobial agent. In accordance with these aspects of the invention, reference to “phenol” means compounds containing the phenol group (benzene ring attached to a hydroxyl group). Illustrative phenol compounds include tocopherols, flavones, and the like. As discussed herein, a cleansing agent is “substantially phenol-free” if the cleansing agent contains phenol in an amount below a level that is capable of providing an antimicrobial effect to the cleansing agent. In some embodiments, the cleansing includes phenol in an amount less than 1% by weight, or less than 0.5% by weight, or less than 0.005% by weight, or less than 0.0025% by weight, or less than 0.001% by weight, based on weight of the total composition. The same principles can be applied to a surface treatment composition that is described as “substantially phenol-free.”

Synthesis

Embodiments of the antimicrobial agents of Formulae (I), (II), and (III) may be prepared, for example, by metathesis. For example, ethylene may be cross-metathesized with an unsaturated compound comprising (a) a triglyceride comprising C₉-C₁₀ unsaturated fatty acid esters, (b) a C₉-C₁₀ unsaturated fatty acid, (c) a C₉-C₁₀ unsaturated fatty ester, or (d) a mixture thereof. The cross-metathesis is typically conducted in the presence of a metathesis catalyst.

In some embodiments, oleic acid is cross-metathesized with ethylene in the presence of a metathesis catalyst to yield 9-decenoic acid according to equation (IV).
CH₃(CH₂)₇CH═CH(CH₂)₇COOH+CH₂═CH₂→CH₂═CH(CH₂)₇COOH+CH₃(CH₂)₇CH═CH₂ (IV)

In other embodiments, methyl oleate is cross-metathesized with ethylene in the presence of a metathesis catalyst to yield the methyl ester of 9-decenoic acid according to equation (V). Methyl oleate may be obtained commercially, for example, from Cognis Inc. (Cincinnati, Ohio) or from NuChek Prep, Inc. (Elysian, Minn.).
CH₃(CH₂)₇CH═CH(CH₂)₇COOCH₃+CH₂═CH₂→CH₂═CH(CH₂)₇COOCH₃+CH₃(CH₂)₇CH═CH₂ (V)

If the unsaturated starting material is in triglyceride form, it may be first hydrolyzed to form free unsaturated fatty acids, followed by cross-metathesis with ethylene to yield 9-decenoic acid. Alternatively, the triglyceride may be cross-metathesized with ethylene followed by hydrolysis to yield 9-decenoic acid. In yet another embodiment, the triglyceride is cross-metathesized with ethylene followed by transesterification with an alcohol to yield an ester of 9-decenoic acid.

In some embodiments, an α-olefin compound is cross-metathesized with an unsaturated starting composition comprising: (a) a triglyceride comprising C9-C10 unsaturated fatty acid esters, (b) a C9-C10 unsaturated fatty acid, (c) a C9-C10 unsaturated fatty esters, or a mixture thereof. The cross-metathesis is typically conducted in the presence of a metathesis catalyst. Useful α-olefin compounds include, for example, 1-butene, 1-propene, 1-pentene, 1-hexene, 1-heptene, 1-octene, and 1-decene, as well as other α-olefins. In addition, useful α-olefins are not limited to aliphatic, linear or hydrocarbons. Cross-metathesis of an α-olefin compound with a C9-10 unsaturated fatty acid, ester, or triglyceride yields a mixture of products including 9-decenoic acid, esters of 9-decenoic acid, and other olefins. The composition of the product depends upon the α-olefin compound that is used and the C9-C10 unsaturated fatty acid, ester, or triglyceride that is used as the starting material.

In an exemplary embodiment as shown in equation (VI), methyl oleate is cross-metathesized with 1-propene in the presence of a metathesis catalyst to yield the methyl ester of 9-decenoic acid and the methyl ester of 9-undecenoic acid, along with other olefin compounds. Methyl oleate may be obtained commercially, for example, from Cognis Inc. (Cincinnati, Ohio) or from NuChek Prep, Inc. (Elysian, Minn.).
CH₃(CH₂)₇CH═CH(CH₂)₇COOCH₃+CH₃CH₂═CH₂→CH₂═CH(CH₂)₇COOCH₃+CH₃(CH₂)₇CH═CH₂+CH₃CH₂═CH(CH₂)₇COOCH₃+CH₃(CH₂)₇CH═CHCH₃ (VI)

If the unsaturated starting material is in triglyceride form, it may be first hydrolyzed to form free unsaturated fatty acids, followed by cross-metathesis with and α-olefin to yield 9-decenoic acid. Alternatively, the triglyceride may be cross-metathesized with an α-olefin followed by hydrolysis to yield 9-decenoic acid. In yet another embodiment, the triglyceride is cross-metathesized with an α-olefin followed by transesterification with an alcohol to yield an ester of 9-decenoic acid. In still another embodiment, the triglyceride is transesterified with an alcohol to yield a fatty acid ester followed by cross-metathesis with an α-olefin to produce the ester of 9-decenoic acid.

In some embodiments, it is desirable to treat the C9-C10 unsaturated starting composition in order to reduce its peroxide value (PV) prior to conducting the cross-metathesis reaction. For example, the starting composition may be treated to reduce the peroxide value to about 1 or less. The peroxide value of the starting material may be reduced by treating the starting composition with an adsorbent such as sodium bisulfite, magnesium silicate, sodium borohydride, or combinations thereof. A useful adsorbent is the magnesium silicate commercially under the trade designation “MAGNESOL” (from Dallas Group of America, Inc.). In order to treat using magnesium silicate, the starting composition is typically heated (e.g., to a temperature of about 80° C.) and stirred while under a nitrogen sparge. After degassing with nitrogen, about 1% weight to about 5% weight magnesium silicate is added and the composition is stirred for a period of time (e.g., about 1 hour) to allow the magnesium silicate to adsorb impurities from the starting composition. In some embodiments, a filter aid (e.g., “CELITE 545” from Sigma-Aldrich, Catalog #61790-53-2) is also added along with the adsorbent. After adsorption, the starting composition is allowed to cool and is filtered one or more times before conducting the cross-metathesis reaction. Prior to performing cross-metathesis, the material is preferably held under nitrogen at freezer temperature (e.g., below about 0° C., more typically in the range of about 10° C. to about −20° C.).

Metathesis Catalysts:

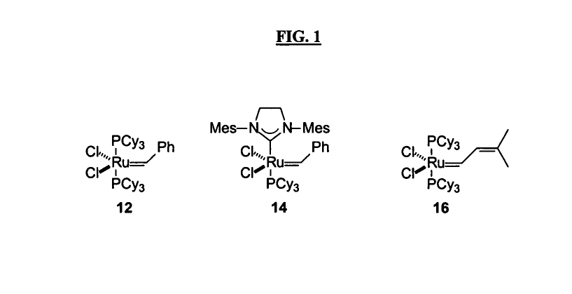

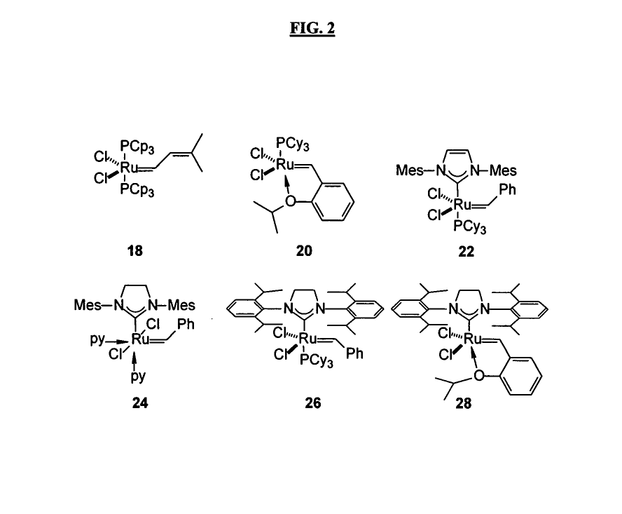

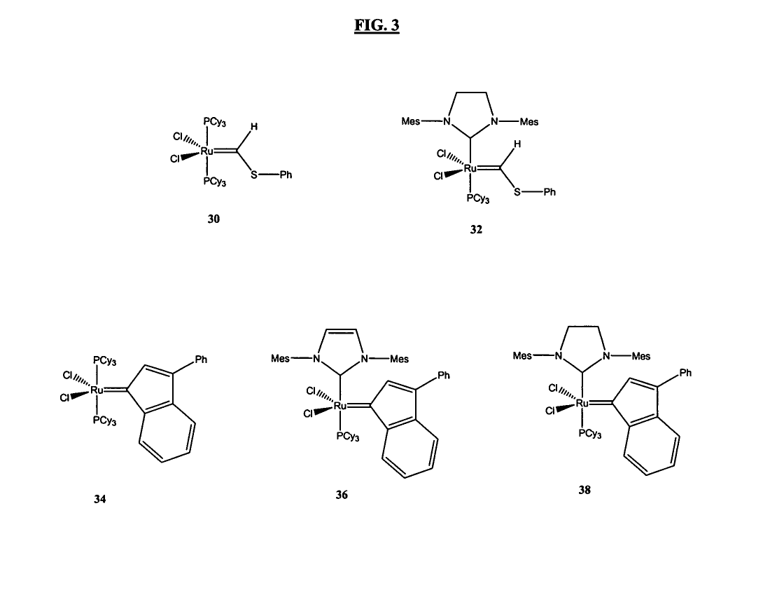

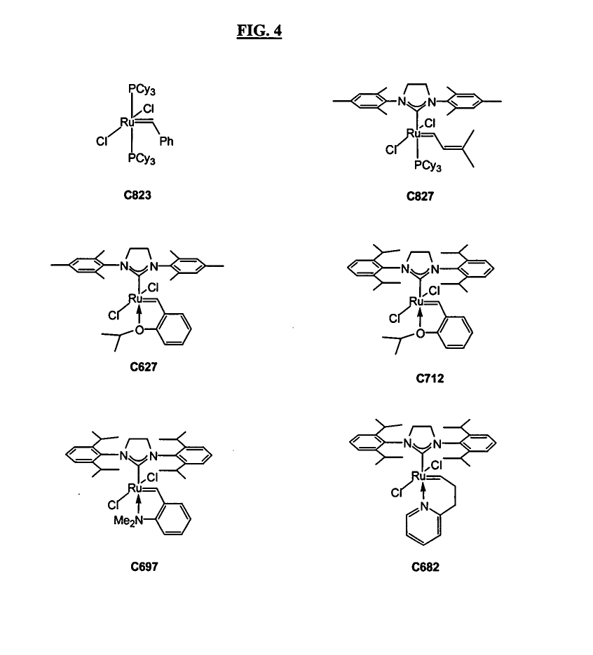

The metathesis reaction is conducted in the presence of a catalytically effective amount of a metathesis catalyst. The term “metathesis catalyst” includes any catalyst or catalyst system which catalyzes the metathesis reaction. Any known or future-developed metathesis catalyst may be used, alone or in combination with one or more additional catalysts. Exemplary metathesis catalysts include metal carbene catalysts based upon transition metals, for example, ruthenium, molybdenum, osmium, chromium, rhenium, and tungsten. Referring to FIG. 1, exemplary ruthenium-based metathesis catalysts include those represented by structures 12 (commonly known as Grubbs's catalyst), 14 and 16. Referring to FIG. 2, structures 18, 20, 22, 24, 26, and 28 represent additional ruthenium-based metathesis catalysts. Referring to FIG. 3, structures 30, 32, 34, 36, and 38 represent additional ruthenium-based metathesis catalysts. Referring to FIG. 4, catalysts C627, C682, C697, C712, and C827 represent still additional ruthenium-based catalysts. In the structures of FIGS. 1-4, Ph is phenyl, Mes is mesityl, py is pyridine, Cp is cyclopentyl, and Cy is cyclohexyl. Techniques for using the metathesis catalysts are known in the art (see, for example, U.S. Pat. Nos. 7,102,047; 6,794,534; 6,696,597; 6,414,097; 6,306,988; 5,922,863; and 5,750,815). Metathesis catalysts as shown, for example, in FIGS. 1-4 are manufactured by Materia, Inc. (Pasadena, Calif.).

Additional exemplary metathesis catalysts include, without limitation, metal carbene complexes selected from the group consisting of molybdenum, osmium, chromium, rhenium, and tungsten. The term “complex” refers to a metal atom, such as a transition metal atom, with at least one ligand or complexing agent coordinated or bound thereto. Such a ligand typically is a Lewis base in metal carbene complexes useful for alkyne or alkene-metathesis. Typical examples of such ligands include phosphines, halides and stabilized carbenes. Some metathesis catalysts may employ plural metals or metal co-catalysts (e.g., a catalyst comprising a tungsten halide, a tetraalkyl tin compound, and an organoaluminum compound).

An immobilized catalyst can be used for the metathesis process. An immobilized catalyst is a system comprising a catalyst and a support, the catalyst associated with the support. Exemplary associations between the catalyst and the support may occur by way of chemical bonds or weak interactions (e.g. hydrogen bonds, donor acceptor interactions) between the catalyst, or any portions thereof, and the support or any portions thereof. Support is intended to include any material suitable to support the catalyst. Typically, immobilized catalysts are solid phase catalysts that act on liquid or gas phase reactants and products. Exemplary supports are polymers, silica or alumina. Such an immobilized catalyst may be used in a flow process. An immobilized catalyst can simplify purification of products and recovery of the catalyst so that recycling the catalyst may be more convenient.

The metathesis process can be conducted under any conditions adequate to produce the desired metathesis products. For example, stoichiometry, atmosphere, solvent, temperature and pressure can be selected to produce a desired product and to minimize undesirable byproducts. The metathesis process may be conducted under an inert atmosphere. Similarly, if a reagent is supplied as a gas, an inert gaseous diluent can be used. The inert atmosphere or inert gaseous diluent typically is an inert gas, meaning that the gas does not interact with the metathesis catalyst to substantially impede catalysis. For example, particular inert gases are selected from the group consisting of helium, neon, argon, nitrogen and combinations thereof.

Similarly, if a solvent is used, the solvent chosen may be selected to be substantially inert with respect to the metathesis catalyst. For example, substantially inert solvents include, without limitation, aromatic hydrocarbons, such as benzene, toluene, xylenes, etc.; halogenated aromatic hydrocarbons, such as chlorobenzene and dichlorobenzene; aliphatic solvents, including pentane, hexane, heptane, cyclohexane, etc.; and chlorinated alkanes, such as dichloromethane, chloroform, dichloroethane, etc.

In certain embodiments, a ligand may be added to the metathesis reaction mixture. In many embodiments using a ligand, the ligand is selected to be a molecule that stabilizes the catalyst, and may thus provide an increased turnover number for the catalyst. In some cases the ligand can alter reaction selectivity and product distribution. Examples of ligands that can be used include Lewis base ligands, such as, without limitation, trialkylphosphines, for example tricyclohexylphosphine and tributyl phosphine; triarylphosphines, such as triphenylphosphine; diarylalkylphosphines, such as, diphenylcyclohexylphosphine; pyridines, such as 2,6-dimethylpyridine, 2,4,6-trimethylpyridine; as well as other Lewis basic ligands, such as phosphine oxides and phosphinites. Additives may also be present during metathesis that increase catalyst lifetime.

Any useful amount of the selected metathesis catalyst can be used in the process. For example, the molar ratio of the unsaturated polyol ester to catalyst may range from about 5:1 to about 10,000,000:1 or from about 50:1 to 500,000:1. In some embodiments, an amount of about 1 to about 10 ppm, or about 2 ppm to about 5 ppm, of the metathesis catalyst per double bond of the starting composition (i.e., on a mole/mole basis) is used.

The metathesis reaction temperature may be a rate-controlling variable where the temperature is selected to provide a desired product at an acceptable rate. The metathesis temperature may be greater than −40° C., may be greater than about −20° C., and is typically greater than about 0° C. or greater than about 20° C. Typically, the metathesis reaction temperature is less than about 150° C., typically less than about 120° C. An exemplary temperature range for the metathesis reaction ranges from about 20° C. to about 120° C.

The metathesis reaction can be run under any desired pressure. Typically, it will be desirable to maintain a total pressure that is high enough to keep the cross-metathesis reagent in solution. Therefore, as the molecular weight of the cross-metathesis reagent increases, the lower pressure range typically decreases since the boiling point of the cross-metathesis reagent increases. The total pressure may be selected to be greater than about 10 kPa, in some embodiments greater than about 30 kPa, or greater than about 100 kPa. Typically, the reaction pressure is no more than about 7000 kPa, in some embodiments no more than about 3000 kPa. An exemplary pressure range for the metathesis reaction is from about 100 kPa to about 3000 kPa.

In some embodiments, the metathesis reaction is catalyzed by a system containing both a transition and a non-transition metal component. The most active and largest number of catalyst systems are derived from Group VI A transition metals, for example, tungsten and molybdenum.

Additional details regarding the production of 9-decenoic acid by metathesis can be found in U.S. Provisional Application Ser. No. 60/851,693, filed Oct. 13, 2006 entitled “Synthesis of Terminal Alkenes From Internal Alkenes Via Olefin Metathesis” and in U.S. Provisional Application Ser. No. 60/851,501, filed Oct. 13, 2006 entitled “Methods of Making Monounsaturated Functionalized Alkene Compounds by Metathesis.”

The 9-decenoic acid (or salt or ester thereof) may be separated from the starting material and other components using known techniques for separation including, for example, distillation.

In some embodiments, the antimicrobial agent comprising 9-decenoic acid (or an ester or salt thereof) that is produced by metathesis is a highly pure composition comprising about 90% weight or greater 9-decenoic acid (or ester or salt thereof), for example, about 95% weight or greater 9-decenoid acid (or ester or salt thereof), about 96% weight or greater 9-decenoic acid (or ester or salt thereof), about 97% weight or greater 9-decenoic acid (or ester or salt thereof), about 98% weight or greater 9-decenoic acid (or ester or salt thereof), about 99% weight or greater 9-decenoic acid (or ester or salt thereof), about 99.5% weight or greater 9-decenoic acid (or ester or salt thereof), about 99.8% weight or greater 9-decenoic acid (or ester or salt thereof), or about 99.9% weight or greater 9-decenoic acid (or ester or salt thereof).

In some embodiments, the antimicrobial agent comprising 9-decenoic acid (or ester or salt thereof) that is produced by metathesis comprises less than about 0.5% weight 8-nonenoic acid (e.g., less than about 0.1% weight 8-nonenoic acid). In other embodiments, the antimicrobial agent comprising 9-decenoic acid (or ester or salt thereof) that is produced by metathesis comprises less than about 0.5% weight of n-decanoic acid (e.g., less than about 0.1% weight n-decanoic acid). In other embodiments, the antimicrobial agent comprising 9-decenoic acid (or ester or salt thereof) that is produced by metathesis comprises less than about 0.5% weight 3-decenoic acid (e.g., less than about 0.1% weight 3-decenoic acid). In other embodiments, the antimicrobial agent comprising 9-decenoic acid (or ester of salt thereof) that is produced by metathesis comprises less than about 0.5% weight undecenoic acid (e.g., less than about 0.1% weight undecenoic acid).

In one exemplary embodiment, the antimicrobial agent comprising 9-decenoic acid (or ester or salt thereof) that is produced by metathesis comprises less than about 0.5% weight 8-nonenoic acid, less than about 0.5% weight n-decanoic acid, less than about 0.5% weight 3-decenoic acid, and less than about 0.5% weight undecenoic acid. In another exemplary embodiment, the antimicrobial agent comprising 9-decenoic acid (or ester or salt thereof) that is produced by metathesis comprises less than about 0.1% weight 8-nonenoic acid, less than about 0.1% weight n-decanoic acid, less than about 0.1% weight 3-decenoic acid, and less than about 0.1% weight undecenoic acid.

Non-metathesis routes to the production of 9-decenoic acid include, for example, the method reported by Black et al., in Unsaturated Fatty Acids. Part I. The Synthesis of Erythrogenic (Isantic) and Other Acetylenic Acids; Journal of the Chemical Society, Abstracts (1953) at pp. 1785-93. As reported by Black, a solution of chromium trioxide (19.0 g) in water (20 cc) was added over 1.5 hours with vigorous stirring to a solution of 1:1 diphenylundeca-1:10-diene (25.0 g) in glacial acetic acid (250 cc) at 35° C. After an additional 0.5 hour stirring, acetic acid (70 cc) was removed under reduced pressure, and 2N sulphuric acid (500 cc) was added to the residue. Extraction of the product with benzene and isolation of the acidic fraction yielded 9-decenoic acid (8.5 g).

9-decenoic acid can also be obtained commercially, for example, from Pyrazine Specialties, Inc. (Athens, Ga.). Whether produced by metathesis or another technique, 9-decenoic acid may be converted to its esters (see, formula II) and salts (see, formula III) according to known synthetic techniques for converting carboxylic acid compounds into esters or salts, respectively.

Combinations

In accordance with some aspects of the invention, combinations of two or more antimicrobial agents can be utilized to formulate a preservative or disinfectant. These combinations can include two or more antimicrobial agents selected from Formula I, II and/or III (referred to herein for purposes of discussion as “Group I” antimicrobial agents). These combinations can be accomplished using any conventional techniques.

For each of the applications described herein, an “antimicrobial agent content” will be described. The antimicrobial agent content is the total amount of antimicrobial agent (or agents), based on total weight of the composition, provided in the product. For example, when only one antimicrobial agent is selected from the agents defined in Formulae I, II or III, then the antimicrobial agent content is the amount of the agent included in the product, based on total weight of the product. In another example, if a combination of two antimicrobial agents (A and B) is provided in a composition, then the antimicrobial agent content is the total of A+B in the composition.

In some aspects, the invention provides antimicrobial compositions that include a combination of any two or more of the antimicrobial agents of Formulae I, II and/or III. In these aspects, the relative amounts of each antimicrobial agent can be selected to provide an overall antimicrobial effect. In some aspects, a combination of acid and salt can occur by virtue of the formulation parameters. For example, as mentioned herein, at calculated pKa of about 4.78 (±0.1), a composition will be composed of approximately equal amounts of 9-decenoic acid and 9-decenoic salt (50/50 9-deceonic acid/salt). In some embodiments, when the antimicrobial composition comprises a combination of two antimicrobial agents, the antimicrobial agents can be provided in a 1:1 ratio. In some aspects, when the antimicrobial composition comprises a combination of two antimicrobial agents, the antimicrobial agents can be provided in a ratio in the range of about 1:10 to about 10:1, or in the range of about 1:5 to about 5:1, or in the range of about 1:1 to about 3:1.

In some aspects, the invention provides antimicrobial compositions that include combinations of an antimicrobial agent of Formula I, II and/or III with one or more second antimicrobial agents (Group II antimicrobial agents). Suitable Group II antimicrobial agents include any antimicrobial agent that is compatible with the antimicrobial agent of Formula I, II and/or III. By “compatible” is meant the antimicrobial agents can be mixed together without adversely affecting one or more useful properties of the individual antimicrobial agents, for example, the ability of the antimicrobial agents to be formulated into a stable composition, such that the individual antimicrobial agents remain in the composition without separating out over time (such as by precipitation).

In these aspects, the antimicrobial composition can provide one or more of the following benefits: broadened spectrum of activity; use of lower concentrations of individual antimicrobial agents, thus minimizing irritancy potential; reduced risk of the development of microbial resistance; synergistic effect, giving greater than the anticipated simple additive effect; potentiation, or activity of an antimicrobial agent is enhanced by combination with a microbiologically inactive or weakly active agent such as EDTA or Monolaurin; and/or improved long-term stability of product by combining a labile, strongly biocidal agent with a stable longer-acting agent.

In some embodiments, when the second antimicrobial agent exhibits higher oral, acute, or aquatic toxicity or higher irritation, formulating a composition that includes a reduced amount of the second antimicrobial agent can provide significant toxicity and/or environmental benefit.

Illustrative second antimicrobial agents include: phenol derivatives (such as halogenated phenols, for example 3,5-dichlorophenol, 2,5-dichlorophenol, 3,5-dibromophenol, 2,5-dibromophenol, 2,5- or 3,5-dichloro-4-bromophenol, 3,4,5-trichlorophenol, 3,4,5-tribromophenol, phenylphenol, 4-chloro-2-phenylphenol, 4-chloro-2-benzylphenol); dichlorophene, hexachlorophene; aldehydes (such as formaldehyde, glutaraldehyde, salicylaldehyde); alcohols (such as phenoxyethanol); antimicrobial carboxylic acids and derivatives thereof such as parabens, including methyl, propyl and benzyl parabens, and the like; organometallic compounds (such as tributyl tin derivatives); iodine compounds (such as iodophors, idonium compounds); quaternary ammonium compounds (such as benzyldimethyldodecylammonium chloride, dimethyldidecylammonium chloride, benzyl-di-(2-hydroxyethyl)-dodecylammonium chloride, dimethyldidecylammonium chloride, benzyl-di-(2-hydroxyethyl)-dodecylammonium chloride)); sulfonium and phosphonium compounds; mercapto compounds and the alkali metal, alkaline earth metal and heavy metal salts thereof, such as 2-mercaptopyridine-N-oxide and the sodium, zinc and copper salts thereof, 3-mercaptopyridazine-2-oxide, 2-mercaptoquinoxaline-1-oxide, 2-mercaptoquinoxaline-di-N-oxide, and also the symmetrical disulfides of these mercapto compounds; ureas (such as tribromocarbanilide or trichlorocarbanilide); dichlorotrifluoromethyldiphenylurea; tribromosalicylanilide; 2-bromo-2-nitro-1,3-dihydroxypropane; dichlorobenzoxazolone; chlorohexidine; isothiazolone and benzisothiazolone derivatives. Further illustrative second antimicrobial agents include Triclosan™ (2,4,4′-trichloro-2′-hydroxydiphenyl ether, also known as 5-chloro-2-(2,4-dichlorophenoxy)phenol) and Kathon™ (methyl chloroisothiazolinone and methyl isothiazolinone in various ratios).

In some embodiments, the phenol derivatives suitable as second antimicrobial agent do not include phenolic compounds having antioxidant properties. Examples of such compounds include BHT, BHA, TBHQ and natural analogues with similar anti-oxidant properties such as tocopherols, cinnamic acid compounds and compounds described as flavins or flavinoids. In some embodiments, the antimicrobial carboxylic acids suitable as second antimicrobial agents do not include short chain organic acids that are water soluble, such as lactic, acetic, citric, malic, succinic, natural amino acids, formic, propionic, butyric, and the like. Illustrative short chain organic acids of this type have four or fewer carbon atoms in the carbon backbone and can also contain other substituent groups such as —OH, NH₂, and the like. In some embodiments, alcohols suitable as second antimicrobial agents do not include short chain alcohols, such as C₁-C₄ alcohols such as methanol, ethanol, propanol, butanol. In these aspects, the antimicrobial agents of Formulae (I), (II) and (III) can be effective in low concentrations without combining with these particular second antimicrobial agents.

Typically, when an antimicrobial agent of Group I is combined with an antimicrobial agent of Group II, the chemical reactivity of the ingredients is taken into consideration during formulation of the product. For example, the agent of Formula I can, in some instances (for example, 9-decenoic acid) be incompatible with a quaternary ammonium ingredient, but in other instances (for example, when formulated as an ester) will mix well.

When an antimicrobial agent of Formula I, II or III is combined with a second antimicrobial agent, the ratio of first to second antimicrobial agent can be in the range of about 1:10 to about 10:1, or in the range of about 1:5 to about 5:1, or in the range of about 1:1 to about 3:1. When more than one antimicrobial agent is selected from Group I and/or Group II, the total amount of antimicrobial agents from Group I can be compared with the total amount of antimicrobial agents of Group II. In these aspects, the ratios identified above for a two-component system can apply. As mentioned elsewhere herein, when more than one antimicrobial agent is included in a preservative or disinfectant system, then the total amount of antimicrobial agent included in the system (antimicrobial agent content) can be the same or less than embodiments where only a single antimicrobial agent is present.

The antimicrobial agent (or agents, when a combination is utilized) can be formulated to provide a preservative or disinfectant composition. In some aspects, the antimicrobial agent can be provided in liquid form, semi-solid or solid form. Illustrative solid forms include particulate, flakes, and the like; illustrative semi-solid forms include pastes, gels and the like.

The antimicrobial agents of the invention can be used to control growth of microorganisms by introducing an antimicrobially effective amount of the agent (or agents) onto, into, or at a locus subject to microbial attack and/or adhesion. These loci can occur in cleansing products (for household or industrial application). In addition, due at least in part to the relatively short amount of time required for the antimicrobial agent(s) to kill a variety of microorganisms, the antimicrobial agents can be utilized to eliminate microorganisms from an environment, thereby providing sanitizing or disinfectant properties to products.

Applications

The antimicrobial agents of Formulae I-III, and compositions that include one or more of these agents, can provide preservative, antiseptic, sanitizing, and/or disinfectant features to a wide variety of end products. Some illustrative common applications that can benefit from the antimicrobial properties described herein (whether they be preservative, antiseptic, sanitizing or disinfectant properties) include a variety of surface treatment compositions including cleansing agents (including cleansing agents for household, industrial and institutional use and personal care), surface treatment compositions for use in connection with a variety of solid surfaces (including food/drinking water contact and non-food contact articles and plastics), and surface treatment compositions for use in connection with textiles.

Illustrative household cleansing agents include dishwashing cleaners, detergents, hard surface cleaners, glass cleaner, appliance cleaner, floor cleaner, bath and kitchen cleaners, auto cleaning and polishing products, water treatment (including cleaners for humidifiers and water softeners), and the like. As used herein, the term “hard surface” includes, but is not limited to, bathroom surfaces (e.g., floor, tub, shower, mirror, toilet, bidet, bathroom fixtures), kitchen surfaces (e.g., counter tops, stove, oven, range, sink, refrigerator, microwave, appliances, tables, chairs, cabinets, drawers, floor), furniture surfaces (e.g., tables, chairs, entertainment centers, libraries, cabinets, desks, doors, shelves, couches, beds, televisions, stereos, pool tables, ping pong tables), windows, window ledges, tools, utility devices (e.g., telephones, radios, CD players, digital sound devices, palm computers, laptop computers), toys, writing implements, watches, framed picture or paintings, and books.

The antimicrobial compositions can be used in a variety of industrial and institutional applications. As used herein, the terms “industrial” and “institutional” mean the fields of use that include, but are not limited to, contract (professional) cleaning and/or disinfecting, as well as cleaning and/or disinfecting services for retail facilities, industrial/manufacturing facilities, office facilities, hotel/restaurant/entertainment facilities, health care facilities (e.g., hospitals, urgent care facilities, clinics, nursing homes, medical/dental offices, laboratories), educational facilities, recreational facilities (e.g., arenas, coliseums, resorts, halls, stadiums, cruise lines, arcades, convention centers, museums, theatres, clubs, family entertainment complexes (indoor and/or outdoor), marinas, parks), food service facilities, governmental facilities, and public transportation facilities (e.g., airports, airlines, cabs, buses, trains, subways, boats, ports, and their associated properties).

Detergents and cleansing agents having excellent antimicrobial action can be obtained by combining one or more of the antimicrobial agents according to the invention with surface-active substances, in particular with active detergents. The detergents and cleansing agents can be in any desired form, for example, in liquid, semi-liquid, or solid form. Illustrative solid forms include, but are not limited to, granular, flake or bulk solid form.

In addition to the household, institutional and industrial applications noted, the antimicrobial agents can be utilized in connection with personal care cleansing agents. Illustrative personal care cleansing agents in accordance with these aspects include, but are not limited to, skin lotions and creams, soap bars, liquid hand and body lotions, liquid hand soaps, bath salts, ointments, face lotions, hair shampoo and conditioning products, hair tonics, skin oils, powders, sunscreen creams, contact lens storage and/or cleansing solution, and the like.

The antimicrobial agents can be used in connection with a wide variety of food/drinking water contact and non-food contact articles such as, but not limited to, adhesives; carpet fibers; carpet backings; rubber or rubber-backed bath mats; foam underlay for carpets; synthetic, non-leather materials; foam stuffing for cushions and mattresses; wire and cable insulation; vinyl, linoleum, tile and other synthetic floor coverings; wall coverings; plastic furniture; athletic flooring and mats; mattress liners, covers or ticking; molding; mats; gaskets; weather stripping; coated fabrics for furniture cushions, boat covers, tents; tarpaulins and awnings; rubber gloves (non-surgical); garbage bags, cans and other refuse containers; bathtub appliqués; garden hose; pipe (non-potable water); ductwork; air filters; air filtration components and media for industrial, hospital, residential, and commercial heating and cooling; conveyor belts; shower curtains; sponge or fiber mats; household use sponges; toilet brush receptacles; toothbrush receptacles (non-bristle contact); scrub brushes (non-medical); sink mats and drain boards; storage containers; soap dish holders; towel bars; components of uppers in footwear; and the like.

Moreover, plastics can be provided with antimicrobial finishes. In these embodiments, it can be advantageous to provide the antimicrobial agent(s), in dissolved or dispersed form, to the plastic in a plasticizer (when used). Such incorporation into the plasticizer can provide a more uniform distribution in the plastic. The plastics with antimicrobial properties can be used for a wide variety of commodities in which activity against microorganisms of diverse kinds is desired (for example, bacteria and fungi). Illustrative applications according to these embodiments include foot mats, bathroom curtains, seating accommodation, drip channel gratings in swimming baths, wall hangings, home food handling items (such as cutting boards, countertops and the like), children's toys, spas.

In other aspects, the inventive antimicrobial systems and methods can find application in laundry or textile fields. For example, the antimicrobial agent can be utilized for the finishing and/or protection of textiles and fibers. For example, the antimicrobial agent can be used as a finish for fibers and textiles. The antimicrobial agent can be applied to natural and synthetic fibers on which they can exert a lasting action against microorganisms such as fungi and bacteria. The antimicrobial agent can be provided to the fiber or textile before, simultaneously with, or after treatment of these materials with other substances such as oil or printing pastes, flame proofing agents, fabric softeners, and other finishing agents. In some embodiments, textiles treated in accordance with the invention can provide protection against perspiration odor caused by microorganisms.

Illustrative textiles that can be finished or preserved include both fibers of natural origin (such as cellulose-containing fibers such as cotton) or polypeptide-containing fibers (such as wool or silk), and fiber materials of synthetic origin, such as those based on polyamide, polyacrylonitrile, or polyester, as well as blends of these fibers.

When utilized in connection with textiles or fibers, the antimicrobial agent can be applied utilizing known techniques. The antimicrobial agent typically contains the active substances in a finely divided form. In particular, solutions, dispersions and emulsions of the antimicrobial agent can be used. Aqueous dispersions can be obtained, for example, from pastes or concentrates, and can be applied as liquids or in the aerosol form.

In general, when used to treat textiles or fibers, the antimicrobial agent can be provided in an amount in the range of about 0.01% to about 5%, or about 0.1% to about 3% of antimicrobial agent, based upon the weight of the textile materials.

The antimicrobial agents of Formulae I-III can be combined with conventional components to provide a variety of consumer products. For cleansing agents, a variety of auxiliary materials can be included, such as fillers, pigments, thickeners, wetting agents, emulsifying agents (for example, polyglycol ethers), surfactants, freeze-thaw stabilizer, solvents, odor-masking agents, excipients (such as organic solvents), complexing agents (such as silicates, carbonates, EDTA, methylglycinediacetic acid trisodium salt), fragrances, colorants, and the like in amounts ordinarily used for the purposes.

For example, when the antimicrobial agent is utilized in a soap or synthetic detergent composition, the compositions can also comprise customary additives, such as sequestering agents, colorants, perfume oils, thickening or solidifying agents (consistency regulators), emollients, UV absorbers, skin-protective agents, antioxidants, additives that improve the mechanical properties, such as dicarboxylic acids and/or aluminum, zinc, calcium and magnesium salts of C₁₄-C₂₂ fatty acids. Detergents can also include laundry adjunct agents such as detergent builder (e.g., water-soluble organic builders), fabric substantive perfumes, scavenger agents selected to capture fugitive dyes and/or anionic surfactants and/or oils, fabric softener, detersive enzyme, chelant, solvent system, effervescent system, and the like.

The antimicrobial agents of the invention can be combined with surface-active agents, for example anionic compounds such as soaps and other carboxylates (such as alkali metal salts of higher fatty acids), derivatives of sulfuroxyacids (such as sodium salt of dodecylbenzenesulfonic acid, water-soluble salts of sulfuric acid monoesters of higher molecular alcohols or of their polyglycol ethers, for example soluble salts of dodecyl alcohol sulfate or of dodecyl alcohol polyglycol ether sulfate), derivatives of phosphorus oxyacids (such as phosphates), derivatives with acid (electrophilic) nitrogen in the hydrophilic group (such as disulfide salts), lauryl sulfate, alkyl succinic, or dodecyl sulfate; as well as with cationic surface-active agents, such as amines and their salts (such as lauryldiethylenetriamine), onium compounds, amine oxides; or nonionic surface-active agents, such as polyhydroxy compounds, surface-active agents based on mono- or polysaccharides, higher molecular acetylene glycols, polyglycol ethers (such as polyglycol ethers of higher fatty alcohols, polyglycol ethers of higher molecular alkylated phenols), or into mixtures of different surfactants. In addition, the soap or synthetic detergent composition can contain conventional adjuvants, for example water soluble perborates, polyphosphates, carbonates, silicates, fluorescent brighteners, plasticizers, acid reacting salts, such as ammonium- or zinc silicofluoride, or certain organic acids (such as oxalic acid), also finishing agents, for example, those based on synthetic resin or on starch. Halogens, such as bromine and iodine, can optionally be included in compositions herein. Similarly, heavy metal salts, such as silver, cerium, and the like, can optionally be included in the compositions described herein.

Some embodiments of the invention provide antimicrobial agents that are soluble in organic solvents. In these aspects, the antimicrobial agents can be suitable for application from non-aqueous media. Moreover, the materials to be treated can be simply impregnated with these solutions. Suitable organic solvents include, for example, trichloroethylene, methylene chloride, hydrocarbons, propylene glycol, methoxyethanol, ethoxyethanol or dimethyl formamide, to which can also be added dispersing agents (for example, emulsifiers such as sulfated castor oil and fatty alcohol sulfates), and/or other adjuvants.

Generally speaking, an effective amount of the antimicrobial agent (or agents) is the amount needed to accomplish an intended purpose, for example, to control microbial growth over time in a composition (preservative function) and/or to cause substantial reduction in microbial population within a desired time period (disinfectant function). These aspects of the invention will now be described.

Thus, the antimicrobial compositions in accordance with the invention can find wide application in industrial products, consumer products, and food/feed applications. Table 2 summarizes some relevant microorganisms and applications that relate to some of these microorganisms.

TABLE 2
Microorganisms Relevant for Various Applications

| | Application |
|---|---|
| Microorganism - Fungi | |
| Aspergillus niger, Penicillium chrysogenum, and | General slime |
| Cladosporium | formation |
| Dermatophytic fungi: Tricophytum sp., | Cosmetics and |
| Microsporum sp., Epidermophytum sp. | toiletries |
| Spoilage fungi: Candida sp., Penicillium sp., | |
| Aspergillus sp. | |
| Candida sp., Pullulaeria pullelelus (chlorine | Polymer emulsions, |
| resistant), Rhotorula sp., and Saccharomyces sp. | consumer products |
| Microorganism | |
| Bacillus sp. | Consumer products |
| Pseudomonas sp. | Consumer products |
| Candida sp. (yeast) | Consumer products, |
| Pseudomonas oleovorans | polymer emulsions |
| E. coli | |
| Proteus mirabilis | |
| Citrobacter freundii | |
| Pseudomonas stutzeri | |
| Fusarium solani | |
| Penicillium sp. | |
| Acremonium strictum | |
| Geotrichum candidum | |
| Microorganism - Fungi | |
| Gram-positive bacteria: Staphylococcus | Personal |
| Corynebacterium, Streptococcus bacillus | Care Products |
| Gram-negative bacteria: Pseudomonas, Klebsiella, | |
| Shigella, Flavobacteria, E. coli, Proteus, | |
| Salmonella, Enterobacter aerogenes, Serratia | |
| marcescens | |
| Yeast: Candida albicans, spoilage yeast, | |
| Pityrosporum ovale | |
| Dermatophytic fungi: Trichophytum sp., | |
| Epidermophytum sp., Microsporum sp. | |
| Spoilage fungi: Cladosporium sp., Aspergillus sp., | |
| Margarinomyces fasciculatis, Trichoderma viride, | |
| Penicillium sp., Stemphylium congestum | |
| Aspergillus parasiticus, Aspergillus flavus, | Food/Feed |
| Aspergillus oryzae, Aspergillus parasiticus, | applications, |
| Alicyclobacillus sp. | including beverage |
| | industry |

Preservatives

In accordance with some aspects of the invention, 9-decenoic acid, salts of 9-decenoic acid, and esters of 9-decenoic acid can be incorporated into compositions to protect the compositions themselves from microbial attack (i.e., as preservatives). In these embodiments, 9-decenoic acid, salts of 9-decenoic acid, and esters of 9-decenoic acid can be utilized as an auxiliary agent within the composition to be preserved and/or protected from microbial attack and/or spoilage.

In accordance with preservative aspects of the invention, the antimicrobial agent is provided in an antimicrobially effective amount. Generally speaking, an antimicrobially effective amount is an amount sufficient to achieve an initial decrease in the population of microorganisms in an environment, followed by maintenance of microbiological stasis within the environment for a period of time. The time periods desired for preservative antimicrobial activity are generally longer than those desired for antiseptics, sanitizers or disinfectants. For example, a preservative activity can include a significant decrease in microbial population within about 7 days of exposure, followed by no increase in microbial population for a period of weeks or months thereafter.

In these aspects, the MIC of the antimicrobial agent can be instructive in selecting the antimicrobial agent or combination of agents, and the projected concentrations that may be useful. From this information, a range of concentrations of the antimicrobial agent can be tested to identify the concentration range exhibiting the desired efficacy. Such testing can be performed using routine methods and without undue experimentation.

In general, the antimicrobially effective amount is the amount needed to pass the particular test protocol used for each separate application. One illustrative standard test that is instructive for determination of preservative function in water-containing formulations is ASTM E640-78 (1998), entitled “Standard Test Method for Preservatives in Water-Containing Cosmetics.” This test describes a microbiological challenge test of preservatives incorporated into formulations at recommended efficacy levels. In accordance with this test, criteria of preservation include: gram-positive and gram-negative bacteria and yeasts should show at least a 99.9% decrease within 7 days following each challenge and no increase thereafter for the remainder of the test within normal variation of the data; and fungi should decrease by at least 90% within 28 days and show no increase during the test period within normal variation of the data. Other suitable testing can be applied for the individual end-use application desired for the preservative.

In some embodiments, the antimicrobially effective amount is equal to the antimicrobial agent content of the system and is an amount in the range of about 2000 ppm or less, or 1250 ppm or less, or about 1000 ppm or less, or about 800 ppm or less, or about 625 ppm or less, which correspond to a weight percent in the range of about 0.2% to about 0.0625% or less, based on the weight of the composition. In some embodiments, an antimicrobially effective amount is in the range of about 0.002% to about 3% by weight, or in the range of about 0.01% to about 1% by weight, based upon the total weight of the composition.

When the preservative agent comprises a combination of two or more antimicrobial agents (e.g., combination of two or more of Formulae I-III and/or one or more agents of Group I with one or more agents of Group II), the antimicrobial agent content can generally be in the range of about 0.002% to about 3%, or about 0.02% to about 2%, all percentages by weight, based upon the total weight of the composition.

The antimicrobial agent can be provided in the form of an aqueous preparation, for example, when providing a detergent or cleansing agent. Such aqueous preparations can be used, in some embodiments, for the antimicrobial finishing of textile materials, since the active substance can be adsorbed substantively onto or into the textile material.

Disinfectants

According to some aspects of the invention, 9-decenoic acid, salts of 9-decenoic acid, and esters of 9-decenoic acid can be employed as an active ingredient in a variety of cleansing agent products for household, institutional, industrial or personal care use. In these embodiments, 9-decenoic acid, salts of 9-decenoic acid, and esters of 9-decenoic acid can be utilized as a disinfectant. The resulting consumer or industrial products can be provided as antimicrobial and/or antibacterial products, such as household cleaning products, liquid soaps, hair care products and other personal care products, and the like.

The formulations according to the invention can exhibit strong biocidal activity in two respects, namely rapid destruction of microorganisms present, and/or long-term biocidal activity within a treated environment (such as a hard surface, for example). Rapid destruction of microorganisms present can be demonstrated, for example, by a variety of industry tests, such as European Standard Test EN1276:1997, entitled, “Chemical Disinfectants and Antiseptics. Quantitative suspension test for the evaluation of bactericidal activity of chemical disinfectants and antiseptics used in food, industrial, domestic, and institutional use. Test method and requirements.” Long-term biocidal activity within a treatment environment can be demonstrated, for example by the American Association of Textile Chemists and Colorists (AATCC) Test Method 100-1993 Method, entitled “Antibacterial Finishes on Textile Materials Assessment of.”

The biocidal function of such compositions can be assessed as follows. A candidate disinfectant composition is brought into contact with a known population of microorganisms for a specified period of time at a specified temperature. The activity of the test material is quenched at specified sampling intervals (for example, at 30 seconds, 60 seconds, or any range covering several minutes or hours) with an appropriate neutralization technique. The test material is neutralized at the sampling time and surviving microorganisms enumerated. The percent or log10 reduction, or both, from either an initial microbial population, or a test blank, is calculated. Basic methods for measuring changes of a population of microorganisms when tested against antimicrobial agents in vitro are described, for example, in ASTM E2315-03 (2003) entitled, “Standard Guide for Assessment of Antimicrobial Activity Using a Time-Kill Procedure.” Illustrative methods for assessing biocidal function are described in the Examples herein.

In general, a biocidally effective amount is the amount needed to pass the particular test protocol used for each separate application. This amount can range from that needed to achieve the rapid kill required for disinfectants, for which a 5-log reduction in microbial population within a 30 second contact time is required by the AOAC Use Dilution Test, to the amount needed to provide the stability required for laundry rinse products with residual sanitizing activity, for which a 3-log reduction in numbers 24 hours after washed fabric is challenged, is required by the American Association of Textile Chemists and Colorists (AATCC) Test Method 100-1974. In some embodiments, a biocidally effective amount is the amount needed to pass the EPA efficacy test requirements for each application.

The biocidally effective amount can be dependent upon such factors as amount of time to kill virtually all microorganisms of a particular type or types in a treatment environment. In some aspects, the biocidally effective amount is an amount sufficient to provide a 2-log reduction, or 3-log reduction, or 4-log reduction, or 5-log reduction in microbial concentration in a sample. For example, the amount of time can be 2 minutes or less, 1 minute or less, or 30 seconds or less. The biocidally effective amount will also depend upon the target microorganisms to be killed in a treatment environment.

In some aspects, a biocidally effective amount can be described with reference to target microorganisms encountered under the conditions of use. For example, a biocidally effective amount can be an amount sufficient to cause a 5-log reduction in Staphylococcus aureus and/or Escherichia coli in two minutes or less, or in 1 minute or less, or in 30 seconds or less. In these embodiments, the target microorganisms are two common organisms carried by humans and animals and often involved in public health issues. Other microorganisms can be selected depending upon the final application of the disinfectant.

In these disinfectant aspects, the MBC of the antimicrobial agent can be instructive. In some embodiments, the biocidally effective amount is equal to the antimicrobial agent content of the system and is about 1250 ppm or less, or about 1000 ppm or less, or about 800 ppm or less, or about 625 ppm or less, which corresponds to a weight percent of about 0.125% to about 0.0625% or less, based on the weight of the composition. In some embodiments, concentrations as low as 10 ppm, which corresponds to a weight percent of about 0.001% based on the weight of the composition, can be useful in providing biocidal activity.

In some aspects, the disinfectant compositions can provide one or more advantages over known disinfectants. For example, disinfectant compositions in accordance with embodiments of the invention can be effective against a wide spectrum of microorganisms at cost-effective concentrations. The antimicrobial agents of Formulae I-III have demonstrated low toxicity and can be obtained from natural sources. In some aspects, the antimicrobial agents are acceptable for food use. In addition, the antimicrobial agents can possess chemical properties that can be beneficial for end use. For example, the antimicrobial agents are capable of being blended with currently approved biocides and can possess chemical compatibility with other components of the final compositions (such as soaps, detergents, and the like). The antimicrobial agents of Formulae I-III are easily handled and safe for use by a consumer and/or formulator. The antimicrobial agents can be fast-acting, some formulations providing biocidal function in as little as 30 seconds or less. The antimicrobial agents of Formulae I-III are easily adaptable to a wide variety of applications, as demonstrated herein. Further, the antimicrobial agents can be effective over the product shelf-life, by not breaking down chemically during storage of the composition.

In addition to the various antimicrobial applications described herein, the disinfectant compositions of the invention can be utilized in connection with applications where quick kill is beneficial and/or in certain food applications. The invention can further provide such products as hand sanitizers, where it is desirable to provide quick kill of microorganisms that are potentially present on the hands of users.

Additional industrial applications for disinfectants and sanitizers include food manufacturing and bottling industries, for example, in breweries, dairies, cheese dairies, slaughterhouses, and the like. Disinfectant compositions can be particularly useful in food and beverage industries to clean and sanitize processing facilities such as pipelines, tanks, mixers, and the like, and continuously operating homogenization or pasteurization apparatus. Other uses for disinfectant compositions include meat surface decontamination, poultry chiller baths, on-site cleaning of food processing equipment, cleaning and disinfecting beverage containers, terminal sterilization, treatment of contaminated infectious waste, and the like.

For disinfecting, a suitable amount of the composition should be applied (diluted according to the indication and the quickness required) over the material or surface to be disinfected. This application can be performed by any conventional method such as immersion, spraying, injection, impregnation with the aid of a suitable applicator for the disinfecting composition over the conduits, surfaces or instruments to be disinfected.

The invention further relates to methods for treating an environment suspected to contain undesirable microorganisms, the method comprising providing the environment with a biocidally effective amount of one or more antimicrobial agents described herein. In some aspects, the antimicrobial agent can be provided for a period of 2 minutes or less, or 1 minute or less, or 30 seconds or less. In some aspects, the antimicrobial agent content can be about 10,000 ppm or less, or 1250 ppm or less, or about 1000 ppm or less, or about 800 ppm or less, or about 650 ppm or less, which correspond to a weight percent of about 1% to about 0.065% or less, based on the weight of the composition. In some embodiments, the antimicrobial agent is an agent of Formula (I), (II) or (III) alone. In other embodiments, one or more compounds of the Formulae (I), (II) and (III) can be combined. In still further embodiments, one or more antimicrobial agents of Formulae (I), (II) and/or (III) can be combined with one or more second antimicrobial agents, as described herein.

The invention will now be described with reference to the following non-limiting examples.

### EXAMPLES

### Example 1

### Minimum Inhibitory Concentration (MIC) and Minimum Bactericidal Concentration (MBC) Determination

The determination of the MIC and MBC of 9-decenoic acid conformed to the procedure printed in the Federal Register, June 1994 and the present NCCLS M11-A4 protocol. Challenge organisms were prepared as follows. The MIC and MBC of 9-decenoic acid and the methyl ester of 9-decenoic acid were determined for the following challenge organisms: Staphylococcus aureus (ATCC 6538), Pseudomonas aeruginosa (ATCC 15442), Staphylococcus epidermidis (ATCC 12228), Klebsiella pneumoniae (ATCC 4352), Escherichia coli 0157:H7 (ATCC 43895) and Candida albicans (ATCC 10231). Stock cultures of each organism were transferred onto suitable culture media, Mueller-Hinton Agar (MHA) plates, and incubated for 24 hours (+2 hours) at 37° C. (+2° C.). On the day of the test, the top of at least three to five well-isolated colonies were transferred via wire loop to a tube containing 4 to 5 ml of Trypticase Soy Broth (TSB). The TSB culture was incubated for 2 to 6 hours and turbidity was adjusted with sterile saline to achieve the turbidity of a McFarland 0.5 Standard.

The concentrated 9-decenoic acid (97%) was diluted in Mueller-Hinton Broth (MHB) to yield a 25,000 ppm stock solution of the 9-decenoic acid. For each organism, 12 dilutions of the 9-decenoic acid in MHB were prepared ranging from 0.25% to 0.00049%. The test solution of the methyl ester of 9-decenoic acid was formulated in the same manner.

A 2-ml aliquot of appropriately diluted 9-decenoic acid solution or methyl ester of 9-decenoic acid was placed in each tube. Each tube was inoculated with 0.05 ml of a 1:10 dilution of one challenge organism. Tubes were incubated at 37° C. (±2° C.) for 20-24 hours and observed for microbial growth visually and by spectrophotometer. For the MBC determination, tubes that exhibited no growth were subcultured on Trypticase Soy Agar (TSA) plates and incubated at 37° C. (±2° C.) for 20-24 hours and visually observed for growth.

Controls were run for sterility, viability and organism confirmation. It was determined that all cultures were viable and pure.

The MIC was defined as the concentration of 9-decenoic acid or the methyl ester of 9-decenoic acid that completely inhibited growth of the challenge organism. The MBC was defined as the concentration of 9-decenoic acid or the methyl ester of 9-decenoic acid that completely eradicated viable organisms from the test system. Results are illustrated in Table 3.

TABLE 3
MIC and MBC of 9-decenoic acid and the methyl ester
of 9-decenoic acid for Challenge Organisms

| | | | Methyl ester of | |
|---|---|---|---|---|
| | 9-decenoic acid | | 9-decenoic acid | |
| Test Organism | MIC (%) | MBC (%) | MIC (%) | MBC (%) |
| Staphylococcus aureus | 0.125 | 0.125 | 0.125 | 0.125 |
| Pseudomonas aeruginosa | 0.0625 | 0.125 | 0.0625 | 0.125 |
| Staphylococcus | 0.125 | 0.125 | 0.125 | 0.25 |
| epidermidis | | | | |
| Klebsiella pneumoniae | 0.0625 | 0.125 | 0.0625 | 0.125 |
| Escherichia coli | 0.125 | 0.125 | 0.125 | 0.125 |
| Candida albicans | 0.0625 | 0.0625 | 0.0156 | 0.0156 |

Results indicated that a single antimicrobial agent (here, 9-decenoic acid or methyl ester of 9-decenoic acid alone), in accordance with one aspect of the invention, provides good MIC levels for a broad spectrum of bacteria and fingi. Results indicated that the MIC against two Gram-negative bacteria (Pseudomonas, Klebsiella) and the yeast Candida was 0.0625%, while the MIC against two Gram-positive bacteria (Staphylococcus) and a Gram-negative bacteria (Escherichia) was 0.125%. Further, the MBC data illustrate the good biocide properties against the fungi Candida, with the methyl ester being more effective (0.0156% vs 0.0625%).

### Example 2

### Time-Kill Determination

The assessment of efficacy of 9-decenoic acid against a spectrum of microorganisms was determined using the American Society for Testing and Materials (ASTM) procedure entitled “Standard Test Method for the Assessment of Microbiocidal Activity of Test Materials Using a Time-Kill Procedure,” October 1998. This procedure incorporates the recommendations described in the “Manual of Clinical Microbiology,” 5^{th} ed., edited by A. B. Balows et al., ASM, Washington, and is directed by the Federal Register, June 1994.

Challenge organisms were prepared as follows. Cultures of the following organisms were obtained: Staphylococcus aureus (ATCC 6538), Pseudomonas aeruginosa (ATCC 15442), Staphylococcus epidermidis (ATCC 12228), Klebsiella pneumoniae (ATCC 4352), Escherichia coli 0157:H7 (ATCC 43895) and Candida albicans (ATCC 10231). The stock cultures were transferred to sterile tubes and sterile tryptic soy broth (TSB) was added to the cultures. The mixture was incubated for 18-24 hours at 37° C. (±2° C.). A portion of this culture was then transferred onto TSA plates and incubated for 18-24 hours at 37° C. (±2° C.). The plates were removed from incubation and the bacterial growth was washed from the agar surface using Butterfield's Phosphate Buffered Dilution Water (PBDW).

The bacterial suspension was adjusted to contain approximately 10⁸ Colony Forming Units (CFU) per ml with PBDW. The concentration was adjusted to an optical density (OD) of 0.4-0.5 (versus a PBDW blank) at 620 nm in a UV-Vis spectrophotometer, and this optical density gave approximately 10⁸ colony forming units per milliliter (cfu/ml). The standardized suspension was stored under appropriate conditions until it was used as the challenge inoculum.

Concentrated 9-decenoic acid (97%) was diluted in filter sterilized isopropanol to yield a 25,000 ppm stock solution. Subsequent dilutions to the 9-decenoic acid stock solutions were made with sterile Deionized Water (DI) to achieve concentrations of 0.1%, 0.05%, 0.01% and 0.001%. The pH was determined for each dilution; pH values ranged from 4.4-4.1. Additionally, 9-decenoic acid stock solution was adjusted to pH 7 with 1 N NaOH and serially diluted with sterile DI to achieve concentrations of 1%, 0.5%, 0.2%, 0.1%, 0.05% and 0.0025%. In addition, 9-decenoic acid stock solution was combined with Triclosan™ (obtained from Ciba Specialty Chemical Corporation, under the tradename Irgasan DP 300™) in various ratios, as indicated in Table 8. The pH of the combined solution was 7.

Compliant with the ASTM procedure cited, for each challenge microorganism a 9.9 ml aliquot of the prepared 9-decenoic acid suspension was added to a sterile tube. A 0.1 ml aliquot of the standardized inoculum was added to the 9-decenoic acid solution representing the start of the test exposure. The inoculated 9-decenoic acid solution was immediately mixed thoroughly. The inoculated suspension was held at room temperature for 0.5, 2, 5, 7 and 10-minute exposure times for tests run at pH level of approximately 4. The pH 7 tests were held at room temperature for 0.5 and 2 minutes.

At each exposure sample time, a 1.0 ml aliquot of the inoculated 9-decenoic acid suspension was transferred to 9.0 ml of D/E Neutralizing Broth. Additional ten-fold serial dilutions were made in PBDW and plated in duplicate on TSA. All plates were incubated for 48 hours at 37° C. (±2° C.) and visually examined for growth. The plates were enumerated, recorded and log kill determined for each time point.

The following study controls were conducted: culture purity, neutralizer sterility, initial suspension population, test population, neutralization verification and a negative control using isopropanol. Culture purity was verified by performing a streak plate for isolated colonies of each culture used. All cultures were determined to be pure based on consistent colony morphology typical for the test organism. The neutralizer sterility was confirmed by no growth in an incubated sample.

The populations of the initial and test culture were determined by serial dilution, plating and enumerating after incubation. The initial suspension were determined to be ≧10⁴ CFU/ml. The test culture population was used for calculation of the log reduction achieved at each time point.

Neutralization effectiveness was verified by a filtration test. For each organism, four tubes were prepared with 9 ml D/E Neutralizing Broth and fewer than 100 CFU/ml of the organism. A 1.0 ml aliquot of prepared 9-decenoic acid was added to each tube. Immediately after addition of the 9-decenoic acid, the entire contents of two tubes were filtered through a filtration apparatus and rinsed with sterile diluent. The remaining two tubes were held at room temperature for 30 minutes and then the entire contents were filtered using the same procedure. The filters were aseptically transferred to TSA plates and incubated for 48 hours at 37° C. (±2° C.) and visually examined for growth. All neutralization controls showed effective recovery of the cultures.

To demonstrate any antimicrobial activity of the isopropanol diluent, a 1:40 dilution of sterile deionized water in isopropanol was made and further diluted as done for the 1000 ppm test concentration of 9-decenoic acid. This control was inoculated, subcultured and incubated as in the test procedure. It was determined that the concentrations of isopropanol used did not contribute to the antimicrobial activity of the test given that <1-log reduction was measured with these controls.

TABLE 4
Log reduction of organisms after exposure
to 0.01% 9-decenoic acid at pH 4.4.

| | Exposure Time (minutes) | | | | |
|---|---|---|---|---|---|
| Test Organism | 0.5 | 2 | 5 | 7 | 10 |
| Staphylococcus aureus | 1.4 | 4.6 | >6.5 | >6.5 | >6.5 |
| Pseudomonas aeruginosa | >6.1 | >6.1 | >6.1 | >6.1 | >6.1 |
| Staphylococcus epidermidis | >5.7 | >5.7 | >5.7 | >5.7 | >5.7 |
| Klebsiella pneumoniae | 1.4 | >6.3 | >6.3 | >6.3 | >6.3 |
| Escherichia coli | 1.3 | 1.6 | 2.2 | 1.8 | 2.7 |
| Candida albicans | 1.0 | 2.9 | >6.7 | >6.7 | >6.7 |

TABLE 5
Log reduction of organisms after exposure
to 0.05% 9-decenoic acid at pH 4.1.

| | Exposure Time (minutes) | | | | |
|---|---|---|---|---|---|
| Test Organism | 0.5 | 2 | 5 | 7 | 10 |
| Staphylococcus aureus | >6.5 | >6.5 | >6.5 | >6.5 | >6.5 |
| Pseudomonas aeruginosa | >6.1 | >6.1 | >6.1 | >6.1 | >6.1 |
| Staphylococcus epidermidis | >5.7 | >5.7 | >5.7 | >5.7 | >5.7 |
| Klebsiella pneumoniae | >6.3 | >6.3 | >6.3 | >6.3 | >6.3 |
| Escherichia coli | >6.2 | >6.2 | >6.2 | >6.2 | >6.2 |
| Candida albicans | >6.7 | >6.7 | >6.7 | >6.7 | >6.7 |

TABLE 6
Log reduction of organisms after exposure
to 0.1% 9-decenoic acid at pH 4.1.

| | Exposure Time (minutes) | | | | |
|---|---|---|---|---|---|
| Test Organism | 0.5 | 2 | 5 | 7 | 10 |
| Staphylococcus aureus | >6.5 | >6.5 | >6.5 | >6.5 | >6.5 |
| Pseudomonas aeruginosa | >6.1 | >6.1 | >6.1 | >6.1 | >6.1 |
| Staphylococcus epidermidis | >5.7 | >5.7 | >5.7 | >5.7 | >5.7 |
| Klebsiella pneumoniae | >6.3 | >6.3 | >6.3 | >6.3 | >6.3 |
| Escherichia coli | >6.2 | >6.2 | >6.2 | >6.2 | >6.2 |
| Candida albicans | >6.7 | >6.7 | >6.7 | >6.7 | >6.7 |

TABLE 7
Log reduction of organisms after exposure to several
concentrations of 9-decenoic acid at pH 7.

| | Test Organism | | | |
|---|---|---|---|---|
| | Staphylococcus aureus | | Escherichia coli | |
| | Exposure time (minutes) | | | |
| 9-decenoic acid conc. | 0.5 | 2 | 0.5 | 2 |
| 0.05% | 0 | 0 | 0 | 0 |
| 0.5% | nd | nd | 0 | 0 |
| 0.75% | 0.67 | 1 | 0.83 | >4.2 |
| 1% | 2.1 | 3.2 | >4.2 | >4.2 |

nd = test not performed

TABLE 8
Interactions between 9-decenoic acid and Triclosan ™ at
pH 7, log reductions of Escherichia coli.

| | Concentration (%) | | Exposure time (min.) | |
|---|---|---|---|---|
| Sample | 9-decenoic acid | Triclosan ™ | 0.5 | 2 |
| A | 0.5 | 0 | 0 | 0 |
| B | 0 | 0.3 | 2.5 | 2.6 |
| C | 0 | 0.15 | 1.3 | 1.6 |
| D | 0 | 0.1 | 0 | 0.1 |
| E | 0.5 | 0.3 | 2 | >4.2 |
| F | 0.5 | 0.15 | 1.3 | 3.8 |
| G | 0.5 | 0.1 | 0.3 | 1.3 |

Results in Tables 4-6 illustrate the efficacy of 9-decenoic acid against a broad spectrum of microorganisms, and in particular illustrate representative time and concentration minimums for biocidal effect of the antimicrobial agent. As shown in Table 4, even at concentrations as low as 0.01%, significant log reduction was seen even at 30 seconds for Pseudomonas and Staphylococcus. By 1 minute, significant log reduction was seen against S. aureus and K. pneumoniae, and by 2 minutes, significant log reduction was also seen against Candida. When the concentration of 9-decenoic acid was increased to 0.05%, significant log reduction was seen at 30 seconds for all challenge microorganisms.

Results obtained at neutral pH values (Table 7) demonstrated a reduction in the disinfectant activity of 9-decenoic acid when compared to the results obtained at acidic pH values (Tables 4-6). This reduction in antimicrobial activity as pH values were increased is commonly observed when the active agent is an organic acid. It was, nonetheless, quite encouraging that 9-decenoic acid demonstrated substantial disinfectant activity at pH 7 when used at concentrations of 0.75% and 1%.

Preliminary research on the disinfectant activity of combinations of active agents at neutral pH values (Table 8) revealed an unexpected interaction between 9-decenoic acid and Triclosan™. The disinfectant activity of marginally-effective concentrations of Triclosan™ was enhanced by 1-2 log reductions when 0.5% 9-decenoic acid was added to the test system. Sample E showed a substantial increase in log reduction of E. coli at 2 minutes, as compared to Sample B (which contained Triclosan™ alone). Sample F showed the same log reduction at 0.5 minutes as compared to Sample C (Triclosan™ alone), but a significant enhancement of log reduction at 2 minutes as compared to Sample C. Results for Sample G showed an enhancement of log reductions at both 0.5 and 2 minutes, as compared to Sample D (Triclosan™ alone). A time kill test was performed in the same manner with the methyl ester of 9-decenoic acid. The results showed less then 1 log reduction for all organisms even after 10 minutes with all concentrations (0.01, 0.05 and 0.1%). Although the methyl ester was not efficacious is this test water system, it was efficacious in liquid complex media (see Table 3). Higher concentrations may be required for effectiveness.

### Example 3

The effectiveness of 9-decenoic acid on food pathogens was determined using the protocol on preservative effectiveness found in the US Pharmacopoeia 23, 1995.

Stock cultures of the Listeria monocytogenes (ATCC 1911-1), Salmonella enteritidis (ATCC 13076) and Campylobacter jejuni (ATCC 29428) were transferred for at least three consecutives days on Trypticase Soy Agar (TSA) and incubated at 30-35° C. for 18-24 hours. On the day of the test, the cells were washed from the agar surface with sterile saline containing 0.05% w/v Polysorbate 80 (SS+) and the suspension was centrifuged at 2000 rpm for 15 minutes and resuspended in SS+. The suspension was diluted to approximately 10⁸ CFU/ml.

The 9-decenoic acid was diluted in the same manner as previously described to achieve concentrations of 0.25%, 0.125%, 0.0625%, 0.03%, 0.015%, 0.0078% and 0.0039%. The samples were dispensed in 20 ml aliquots in sterile test tubes. For each concentration tested, a 0.1 ml aliquot of each inoculum was added to a final concentration of 10⁵ to 10⁶ CFU/ml. The tubes were incubated at room temperature and sampled on days 0, 1, 2, 4, 7, 14, 21 and 28.

At each sample point, 1.0 ml aliquots were withdrawn, serially diluted and plated in triplicate on TSA. The plates were incubated at 30-35° C. for 2-4 days. The colonies were counted and the average CFU/ml was calculated. Controls for purity, viability and sterility were performed as described previously.

According to the US Pharmacopoeia, a test compound is an effective preservative if the concentrations of viable bacteria remain at or below the initial concentrations during the first fourteen days and after 28 days. According to this definition, results demonstrated that 9-decenoic acid is an effective preservative against Listeria monocytogenes, Salmonella enteritidis and Campylobacter jejuni at concentrations as low as 0.0078%.

In addition, results demonstrated that 9-decenoic acid was bactericidal against L. monocytogenes after 1 day at 0.0078% and at day 0 at 150 ppm and against S. enteritidis after 7 days at 0.0078% and at day 0 at 0.015%. For C. jejuni, 9-decenoic acid was bactericidal at day 2 at 0.0078%, day 1 at 0.0015% and day 0 for 0.003%.

Additionally, test organisms in Tables 9-11 were exposed to the 9-decenoic acid for several minutes before analysis at Day 0. As shown in the Tables 9-11, significant biocidal activity was observed even within this short time period for the test organisms, illustrating the effectiveness of 9-decenoic acid as a biocidal agent.

TABLE 9
Log reduction of organisms after exposure
to 0.0078% 9-decenoic acid.

| | Exposure Time (days) | | | | | | | |
|---|---|---|---|---|---|---|---|---|
| Test Organism | 0 | 1 | 2 | 4 | 7 | 14 | 21 | 28 |
| Listeria monocytogenes | 1.0 | 5.1 | 5.1 | 5.1 | 5.1 | 5.1 | 5.1 | 5.1 |
| (ATCC 19111) | | | | | | | | |
| Salmonella enteritidis | 0.53 | 3.2 | 4.1 | 4.0 | 5.1 | 5.1 | 5.1 | 5.1 |
| (ATCC 13076) | | | | | | | | |
| Campylobacter jejuni | 0 | 0.67 | 5.1 | 5.1 | 5.1 | 5.1 | 5.1 | 5.1 |
| (ATCC 29428) | | | | | | | | |

TABLE 10
Log reduction of organisms after exposure
to 0.015% 9-decenoic acid.

| | Exposure Time (days) | | | | | | | |
|---|---|---|---|---|---|---|---|---|
| Test Organism | 0 | 1 | 2 | 4 | 7 | 14 | 21 | 28 |
| Listeria monocytogenes | 5.1 | 5.1 | 5.1 | 5.1 | 5.1 | 5.1 | 5.1 | 5.1 |
| (ATCC 19111) | | | | | | | | |
| Salmonella enteritidis | 5.1 | 5.1 | 5.1 | 5.1 | 5.1 | 5.1 | 5.1 | 5.1 |
| (ATCC 13076) | | | | | | | | |
| Campylobacter jejuni | 2.8 | 5.1 | 5.1 | 5.1 | 5.1 | 5.1 | 5.1 | 5.1 |
| (ATCC 29428) | | | | | | | | |

TABLE 11
Log reduction of organisms after
exposure to 0.03% 9-decenoic acid

| | Exposure Time (days) | | | | | | | |
|---|---|---|---|---|---|---|---|---|
| Test Organism | 0 | 1 | 2 | 4 | 7 | 14 | 21 | 28 |
| Listeria monocytogenes | 5.1 | 5.1 | 5.1 | 5.1 | 5.1 | 5.1 | 5.1 | 5.1 |
| (ATCC 19111) | | | | | | | | |
| Salmonella enteritidis | 5.1 | 5.1 | 5.1 | 5.1 | 5.1 | 5.1 | 5.1 | 5.1 |
| (ATCC 13076) | | | | | | | | |
| Campylobacter jejuni | 5.1 | 5.1 | 5.1 | 5.1 | 5.1 | 5.1 | 5.1 | 5.1 |
| (ATCC 29428) | | | | | | | | |

### Example 4

### Efficacy of Antimicrobial Compositions

The efficacy of antimicrobial compositions in accordance with aspects of the invention against the following organisms was determined as follows. The following organisms were incubated in the presence of varying concentrations of 9-decenoic acid (9-DA) on an agar surface: Aspergillus parasiticus (ATCC 56857), Trichoderma virens (ATCC 9645), Aspergillus flavus (ATCC 96045), Cladosporium cladosporiodes (ATCC 16022), Aspergillus flavus (ATCC 5917), Aspergillus oryzae (ATCC 10124), Aspergillus parasiticus (ATCC 13539), Ulocladium atrum (ATCC 52426), Candida albicans (ATCC 11651), Aspergillus niger (ATCC 11414).

The minimum inhibitory concentration (MIC) was defined as the least concentration tested that completely inhibited growth of the organism.

Fungal spores were hydrated in 0.1% Tween 80 and then plated onto Potato Dextrose Agar (PDA) (Difco # 213400; Becton, Dickinson and Company, Sparks, Md.) and incubated at 25-30° C. for six (6) days. The spores were washed from the surface with 5 ml of 0.1% Tween 80 and enumerated.

PDA plates were prepared according to the manufacturer's instructions through sterilization. The agar was tempered to approximately 50° C. and filter sterilized. Antimicrobial compositions containing 9-DA were added by percent weight to molten autoclaved PDA media, with consideration of specific gravity (0.915 g/mL for 9-DA) and purity (98% for 9-DA). The agar was thoroughly mixed and poured into sterile petri plates and allowed to solidify.

The pH of all concentrations of 9-DA in PDA media used was as follows:

TABLE 12

| Media | PH |
|---|---|
| PDA | 5.68 |
| 1.0% 9-DA | 4.62 |
| 0.1% 9-DA | 5.39 |
| 0.05% 9-DA | 5.44 |
| 0.025% 9-DA | 5.53 |

The MIC for 9-DA, 9-DA/9-UDA and 9-UDA are shown in Table 13 below:

TABLE 13
MIC for Antimicrobial Compositions.

| Microorganism (ATCC number) | 9-DA MIC (%) |
|---|---|
| Aspergillus parasiticus 56857 | 0.05 |
| Trichoderma virens 9645 | 0.05 |
| Aspergillus flavus 96045 | 0.05 |
| Cladosporium cladosporiodes 16022 | 0.025 |
| Aspergillus flavus 5917 | 0.05 |
| Aspergillus oryzae 10124 | 0.05 |
| Aspergillus parasiticus 13539 | 0.05 |
| Ulocladium atrum 52426 | 0.025 |
| Candida albicans 11651 | 0.025 |
| Aspergillus niger 11414 | 0.05 |

The agar plates were inoculated with the spore solution to achieve 10² spores/plate. The plates were incubated at 25-30° C. in Ziploc bags with a wet paper towel to keep the moisture level high. The plates were examined for growth at 1, 2, 3, 4, 8, 11, 15, 17, 23, 29 and 31 days. The percent coverage of growth on the agar surface was recorded at each sample point.

For all fungal strains tested above, 9-DA was observed to be an effective antimicrobial agent with MICs in the ranges of 0.025% to 0.05%.

### Example 5

### Efficacy of Salts of 9-DA

Efficacy of potassium salts of 9-DA were determined through incubation of the following organisms in the presence of varying concentrations of the potassium salt: Serratia marcescens ATCC 990, Pseudomonas straminea ATCC 33636, Bacillus subtilis ATCC 6051, Bacillus licheniformis ATCC 14580, Bacillus cereus ATCC 14579, Pediococcus acidilactici ATCC 8042, and Lactobacillus casei ATCC 334.

Stock cultures of each organism were transferred into MRS liquid medium. MRS medium (Difco 288130) was purchased from Becton, Dickinson and Company, Sparks, Md.

The efficacy of different levels of potassium salts of 9-DA (K-9-DA) was tested depending on the organism to inhibit the growth of various microorganisms indicated above.

The selected organisms were incubated overnight in 5 ml of MRS medium at 35° C. and 250 rpm. MRS media with K-9-DA were prepared, along with a control of straight media (no antimicrobial added). The concentrated antimicrobial agents were diluted with the appropriate media required for the respective microorganisms, to reach the required concentrations for the studies as indicated below. The antimicrobial agents were added by weight/volume percent on an ‘as 9-DA’ basis to the media. The purity of the antimicrobial agent (99% for K-9-DA) was taken into account. The pH of the medium was not adjusted. The target for initial cell density was 10⁵ to 10⁶ cfu/ml. According to the McFarland standard, 0.01 OD₆₀₀ is equivalent to approximately 10⁸ cfu/ml. To achieve the proper dilution, 30 μl of overnight culture diluted to 0.01 OD₆₀₀ was added to the 3 ml of media in each tube. The tubes were incubated at 35° C. Treatments were all done in duplicate. All strains were shaken at 250 rpm, with the exception of Lactobacillus (because it is anaerobic). OD₆₀₀ readings were taken at 0, 4, 17, 23 and 47 hours.

“Percent reduction in comparison with control” was defined as (1−abs. of treatment/abs. of control)×100. Results are illustrated in the Table 14 below:

TABLE 14

| | | | Potassium-9 | |
|---|---|---|---|---|
| | | | Decenoic Acid | |
| | | | | % reduction in |
| | | Abs. at 600 | Abs at 600 | growth vs. |
| Organism | w/v % antimicrobial | nm for control | nm | control |
| Serratia | 0% control | 7.700 | | |
| marcescens | | | | |
| | 0.1% 9DA from K9DA | | 0.412 | 94.6 |
| | 0.075% 9DA from K9DA | | 0.181 | 97.7 |
| Pseudomonas | 0% control | 6.080 | | |
| straminea | | | | |
| | 0.075% 9DA from K9DA | | 0.165 | 97.3 |
| | 0.05% 9DA from K9DA | | 0.190 | 96.9 |
| Bacillus | 0% control | 5.730 | | |
| subtilis | | | | |
| | 0.075% 9DA from K9DA | | 0.094 | 98.4 |
| | 0.05% 9DA from K9DA | | 0.157 | 97.3 |
| Bacillus | 0% control | 2.635 | | |
| licheniformis | | | | |
| | 0.1% 9DA from K9DA | | 0.023 | 99.1 |
| | 0.075% 9DA from K9DA | | 0.300 | 88.6 |
| Bacillus | 0% control | 5.655 | | |
| cereus | | | | |
| | 0.1% 9DA from K9DA | | 0.216 | 96.2 |
| | 0.075% 9DA from K9DA | | 0.093 | 98.4 |
| Pediococcus | 0% control | 5.775 | | |
| acidilactici | | | | |
| | 0.05% 9DA from K9DA | | 0.224 | 96.1 |
| | 0.025% 9DA from K9DA | | −0.038 | 100.0 |
| Lactobacillus | 0% control | 6.835 | | |
| casei | | | | |
| | 0.075% 9DA from K9DA | | 0.211 | 96.9 |
| | 0.05% 9DA from K9DA | | 0.461 | 93.3 |

All grown in MRS
n = 2 for all

Within the above table, complete growth inhibition is highlighted in bold font for the particular microorganisms and composition tested. In addition, it can be seen that with the exception of Serratia marcescens, Bacillus licheniformis, and Lactobacillus casei, all concentrations of the potassium salts of 9-DA resulted in at least a 96% reduction in growth when compared to the appropriate controls cultivated in MRS medium in the absence of any antimicrobial compound. In the case of B. licheniformis, 0.075% potassium 9-DA resulted in an 88.6% reduction in growth when compared with the appropriate control as described above.

It should be noted that MRS medium is considered to be a rich medium by those skilled in the art and one would expect the potassium salts of 9-DA to be even more effective in sub-optimal culture conditions for the various microorganisms tested. Thus it is expected that even greater reductions in growth when compared with growth could be observed with even lower concentrations of the antimicrobial compounds that those listed above.

### Example 6

### Efficacy of Salts of 9DA

Efficacy of potassium salts of 9-DA was tested at various pH levels against the following: Serratia marcescens ATCC 990, and Bacillus cereus ATCC 14579.

Stock cultures of each organism were transferred into MRS liquid medium. MRS medium (Difco 288130) was purchased from Becton, Dickinson and Company, Sparks, Md.

The efficacy of potassium salts of 9-DA (K-9-DA) was tested at different concentrations and pH levels, including 6.75 (unadjusted), 7.5, and 8.5.

The selected organisms were incubated overnight in 5 ml of MRS medium at 35° C. and 250 rpm. MRS media with K-9-DA were prepared, along with a control of straight media (no antimicrobial added). The antimicrobial agents were added by weight/volume percent to the media. The purity of the composition, 99% for K-9-DA, was taken into account. The pH adjustments to 7.5 and 8.5 were done with 50% potassium hydroxide. Filter sterilization was used instead of autoclaving to prevent adverse chemical reactions at higher pH and temperature. The target for initial cell density was 10⁵ to 10⁶ cfu/ml. According to the McFarland standard, 0.01 OD₆₀₀ is equivalent to approximately 10⁸ cfu/ml. To achieve the proper dilution, 30 μl of overnight culture diluted to 0.01 OD₆₀₀ was added to the 3 ml of media in each tube. The tubes were incubated at 35° C. with the exception of Pseudomonas strains which were incubated at 30° C. Treatments were all done in duplicate. All strains were shaken at 250 rpm. OD₆₀₀ readings were taken at 0, 19, 25.5, 42.5 and 49 hours.

“Percent reduction in growth vs. control” was defined as (1−abs. of treatment/abs. of control)×100. Results are illustrated in the Tables 15-17 below:

TABLE 15

| | Potassium-9 Decenoic Acid |
|---|---|
| Organism | 0.1% w/v (as 9DA) % reduction |
| Serratia marcescens | in growth vs. control |
| Non-pH adjusted | 98.5 |
| pH 7.5 | 18.5 |
| pH 8.5 | 37.4 |

TABLE 16

| | Potassium-9 Decenoic Acid |
|---|---|
| Organism | 0.075% w/v (as 9DA) % reduction |
| Pseudomonas straminea | in growth vs. control |
| Non-pH adjusted | 98.6 |
| pH 7.5 | 96.2 |
| pH 8.5 | 93.9 |

TABLE 17

| | Potassium-9 Decenoic Acid |
|---|---|
| Organism | 0.1% w/v (as 9DA) % reduction |
| Bacillus cereus | in growth vs. control |
| Non-pH adjusted | 96.5 |
| PH 7.5 | 96.2 |
| PH 8.5 | 93.9 |

Results further indicated that in the case of all organisms tested above, in Tables 15-17, with the exception of Serratia marcescens, at the concentrations of the antimicrobial agent used (indicated in the table above), the various concentrations of potassium salt of 9-DA tested, resulted in a 96% reduction in growth at pH 7.5 when compared with the appropriate control organisms grown at the same pH. Various concentrations of the potassium salt of 9-DA tested resulted in a 94% reduction in growth at pH 8.5 when compared with the appropriate control organisms grown at the same pH, with the exception of Serratia marcescens.

Based on the observations in Tables 15-17, it is expected that increasing the potassium 9-DA concentrations would be required for complete inhibition of growth of those microorganisms that did not show complete growth inhibition at the concentrations of antimicrobial used in this study.

It should also be noted that these studies were performed in rich media under optimal growth conditions for the various microorganisms. Therefore in some cases the use of lower amounts of the antimicrobial could be efficacious in various products or applications where inhibition of specific microbes is desired.

Further, it is surprising that the potassium salts of 9-DA exhibited significant antimicrobial activity at pH levels of 8.5. Typically, it has been observed that effectiveness for conventional antimicrobial agents fails around neutral pH levels. Thus, in accordance with some aspects of the invention, the antimicrobial compositions can provide significant benefits over known antimicrobial agents, in light of this additional pH range of efficacy.

### Example 7

### Magnesol Purification Technique

This treatment reduces the peroxide value (PV) in the seed oil starting material prior to propenolysis conditions.

Materials:

300 g FAME

2.5% Magnesol (1% and 5% also used)

1.25% Celite 545 EM Science lot AD42050

2-125 mL narrow mouth amber jars

1-60 ml amber jars

Whatmann #4 and #2 filter paper

Nitrogen

Apparatus:

A 3-necked 500 mL round bottom flask with stir bar, thermocouple/controller/heating mantel, nitrogen sparge needle with mineral oil filled bubbler, and Buchner funnel and flask was used.

Procedure:

1. The flask was filled with 300 grams of FAME.

2. The stir bar was started.

3. A nitrogen sparge was started.

4. The FAME was heated to 80° C.

5. The FAME was held for 45 minutes to degas.

6. 2.5 wt % Magnesol, and 1.5 wt % Celite were added to the degassed FAME.

7. The resulting composition was held for 1 hour to allow the Magnesol to adsorb.

8. The heating mantel was removed.

9. When the temperature reached 40° C. the nitrogen sparge was stopped.

10. The resulting composition was filtered through #4 paper on a Buchner funnel.

11. After filtering with #4 paper, the composition was filtered twice through Buchner funnel fitted with #2 filter paper.

12. The filtered composition was placed in amber bottles and was sparged with nitrogen for 5 minutes followed by 1 minute blanketing of the headpace with nitrogen.

14. The jars were capped and sealed and were stored in a freezer.

Propenolysis Reaction

Fisher Porter vessels and regulators (valves opened) were brought into a glovebox along with a 10 ml volumetric flask. Seed oil or Soy FAME (10 to 20 g) was pipetted into Fisher Porter vessels. A stock catalyst solution was made in a volumetric flask, using methylene chloride, and the appropriate concentration added to the Fisher Porter vessels. The vessels were attached to the regulator heads and the valves were closed. The equipment was removed from the glovebox and was hooked up to a steel manifold with propene feed or straight to small propene tank. After clearing the lines with propene (line is loosely attached to fisher porter head), the lines were tightened onto the head and the solution was sparged three times with propene by allowing it to pressurize to 130 psi and venting. The solution was then pressurized again to 130 psi and was closed and heated to 60° C. with stirring. As the catalyst consumes the propene, the solution was continually brought back to 130 psi by opening and closing the valve. Closing the valve prevents any backflow into the gas cylinder if it is not outfitted with a regulator. Reactions were quenched and metathesis catalyst removed after four hours as described below.

Catalyst Removal Procedure

A 1.0 M solution of tris(hydroxymethyl)phosphine (THMP) in IPA (25 mol equiv of THMP per mole of metathesis catalyst) was added to the metathesized oil and the mixture was heated at 70° C. for 6 hours (under argon) (R. L. Pederson; I. M. Fellows; T. A. Ung; H. Ishihara; S. P Hajela Adv. Syn. Cat. 2002, 344, 728). Hexane was added if needed to formed a second phase when the mixture was washed 3 times with water. The organic phase was dried with anhydrous Na₂SO₄, filtered and analyzed by GC analysis.

Transesterification of Metathesized SBO

To a glass 3-necked round bottom flask with a magnetic stirrer, condenser, temperature probe, and a gas adapter was charged with crude metathesized SBO product (˜2 L) and 1% w/w NaOMe in MeOH. Resulted light yellow heterogeneous mixture was stirred at 60° C. for 1 hr. Towards the end of the hour, the mixture turned a homogeneous orange color. Esterified products were transferred into the separatory funnel and extracted with 2.0 L DI-H₂O. The aqueous layer was then extracted with 2×2.0 L Et₂O. The combined organic extracts were dried over 300 g. of anhydrous Na₂SO₄ for 20 hours. The solution of esterified products was filtered and the filtrate was stripped of solvent via rotary evaporator.

Vacuum Distillation

A glass 2.0 L 3-necked round bottom flask with a magnetic stirrer, packed column, distillation head, and temperature controller was charged with methyl ester products and placed in the heating mantle. The flask was attached to a 2-inch×36-inch glass distillation packed column contain 0.16″ Pro-Pak™ stainless steel saddles. Distillation column was adapted to a fractional distilling head, which was connected to the vacuum line; a 500 mL pre-weighed round bottom flask was collecting the fractions. Vacuum on this system was <1 mmHg.

GC Analysis Conditions and Methods

The products were analyzed using an Agilent 6890 gas chromatography (GC) instrument with a flame ionization detector (FID). The following conditions and equipment were used:

| Column: | Rtx-5, 30 m × 0.25 mm (ID) × 0.25 μm film thickness. |
|---|---|
| | Manufacturer: Restek |
| GC and column | Injector temperature: 250° C. |
| conditions: | Detector temperature: 280° C. |
| Oven | Starting temperature: 100° C., hold time: 1 minute. |
| temperature: | Ramp rate 10° C./min to 250° C., hold time: 12 minutes. |
| | Carrier gas: Helium |
| Mean gas | 31.3 ± 3.5% cm/sec (calculated) |
| velocity: | |
| Split ratio: | ˜50:1 |

The products were characterized by comparing peaks with known standards, in conjunction with supporting data from mass spectrum analysis (GCMS-Agilent 5973N). GCMS analysis was accomplished with a second Rtx-5, 30m×0.25 mm (ID)×0.25 μm film thickness GC column, using the same method as above. The Compound Abbreviations are used through the following Tables.

TABLE 18
GC Analysis of Products from the Cross Metathesis
of Seed Oils with 1-Propene or 1-Butene.

| | | Compound |
|---|---|---|
| Ret Time | Compound | Abbreviation |
| 1.300 | E-2-Octene | 2C₈ |
| 1.596 | 3-Nonene | 3C₉ |
| 2.039 | 1-Decene | 1C₁₀ |
| 2.907 | E-2-Undecene | E-2C₁₁ |
| 3.001 | Z-2-Undecene | Z-2C₁₁ |
| 3.836 | 3-Dodecenes | 3C₁₂ |
| 5.298 | Methyl 9-Decenoate | 9C₁₀O₂Me (9DA) |
| 6.708 | Methyl E-9-Undecenoate | E-9C₁₁O₂Me (9UDA) |
| 6.852 | Methyl Z-9-Undecenoate | Z-9C₁₁O₂Me (9UDA) |
| 7.419 | Pentadecadienes | nC₁₅ |
| 7.816 | Methyl E-9-Dodecenoate | E-9C₁₂O₂Me |
| 7.894 | Methyl Z-9-Dodecenoate | Z-9C₁₂O₂Me |
| 10.939 | 9-Octadecene | 9C₁₈ |
| 11.290 | Methyl 9-12 tetradecadienoate | 9,12C₁₄O₂Me |
| 12.523 | Methyl palmitate | C₁₆O₂Me |
| 14.306 | Methyl linoleates | 9,12C₁₈O₂Me |
| 14.363 | Methyl oleates | 9C₁₈O₂Me |
| 14.537 | Methyl stearate | C₁₈O₂Me |
| 17.138 | Methyl 9,21-Henicosadienaote | 9,12C₁₈O₂Me |
| 17.586 | 1,18 Dimethyl ester of 9-Ocadecene | 9,12C₁₈O₂Me |
| 22.236 | Methyl 9,12,15-docosatrienoate | 9,12,15C₂₁O₂Me |

TABLE 19
Propenolysis of Treated SBO and Soy FAMEs (20 g) for 4 hours at 60° C.

| Exp# | Oil | Lot # | Cat ppm | Treatment | % 1C₁₀ | % 2C₁₁ | % 9DA | % 9uDA | C18:0 | TON_{9DA} | TONₜₒₜₐₗ | 9DA/C18:0 |
|---|---|---|---|---|---|---|---|---|---|---|---|---|
| 129-108A | Soy FAME | B6 | C827(10) | Magnesol¹ | 8.33 | 5.24 | 24.90 | 16.38 | 5.58 | 24900 | 54850 | 4.46 |
| 129-108D | ″ | ″ | C827(5) | Magnesol¹ | 8.07 | 4.92 | 24.06 | 13.95 | 5.63 | 48120 | 102000 | 4.27 |
| 129-108E | ″ | ″ | C827(2.5) | Magnesol¹ | 6.99 | 4.45 | 20.08 | 11.97 | 5.62 | 80320 | 173960 | 3.57 |
| 129-108F | ″ | ″ | C827(1) | Magnesol¹ | 7.47 | 5.10 | 19.22 | 12.10 | 5.21 | 192200 | 438900 | 3.69 |
| 129-108B | Biodiesel | B7 | C827(10) | Magnesol² | 8.27 | 5.28 | 25.17 | 15.65 | 5.44 | 25170 | 54370 | 4.63 |
| 129-108G | ″ | ″ | C827(5) | Magnesol² | 8.21 | 5.00 | 23.45 | 13.39 | 5.55 | 46900 | 100100 | 4.23 |
| 129-108H | ″ | ″ | C827(2.5) | Magnesol² | 5.52 | 3.95 | 14.68 | 9.31 | 5.49 | 58720 | 133840 | 2.67 |
| 129-108I | ″ | ″ | C827(1) | Magnesol² | 2.98 | 2.15 | 5.38 | 4.34 | 5.12 | 53800 | 148500 | 1.05 |
| 129-108C | ″ | B8 | C827(10) | Magnesol¹ | 8.14 | 5.23 | 24.48 | 14.96 | 5.58 | 24480 | 52810 | 4.39 |
| 129-108J | ″ | ″ | C827(5) | Magnesol¹ | 7.43 | 4.59 | 20.88 | 11.95 | 5.34 | 41760 | 89700 | 3.91 |
| 129-108K | ″ | ″ | C827(2.5) | Magnesol¹ | 5.04 | 4.33 | 10.64 | 7.49 | 5.07 | 42560 | 110000 | 2.10 |
| 129-108L | ″ | ″ | C827(1) | NaHSO₃ | 4.67 | 4.22 | 9.16 | 6.84 | 5.02 | 91600 | 248900 | 1.82 |
| 129-108M | ″ | C5 | C827(10) | Magnesol² | 7.95 | 5.04 | 24.37 | 14.89 | 5.14 | 24370 | 52250 | 4.74 |
| 129-108N | SBO | D1 | C827(10) | Magnesol² | 7.89 | 4.83 | 24.25 | 14.25 | 5.15 | 24250 | 51220 | 4.71 |
| 129-108O | ″ | D4 | C827(10) | Magnesol² | 7.15 | 5.55 | 20.15 | 15.67 | 5.31 | 20150 | 48520 | 3.79 |

¹Added 2.5 wt % Magnesol.
²Added 5.0 wt % Magnesol.

Other embodiments of this invention will be apparent to those skilled in the art upon consideration of this specification or from practice of the invention disclosed herein. Variations on the embodiments described herein will become apparent to those of skill in the relevant arts upon reading this description. The inventors expect those of skill to use such variations as appropriate, and intend to the invention to be practiced otherwise than specifically described herein. Accordingly, the invention includes all modifications and equivalents of the subject matter recited in the claims as permitted by applicable law. Moreover, any combination of the above-described elements in all possible variations thereof is encompassed by the invention unless otherwise indicated. All patents, patent documents, and publications cited herein are hereby incorporated by reference as if individually incorporated. In case of conflict, the present specification, including definitions, will control.

We claim:

1. A method of treating a surface, the method comprising applying a surface treatment composition to a surface, wherein the surface treatment composition includes a substantially phenol-free cleansing agent and an antimicrobial agent, the antimicrobial agent comprising 9-decenoic acid, a salt of 9-decenoic acid, an ester of 9-decenoic acid, or a combination thereof, wherein the antimicrobial agent is present in an amount sufficient to control microbial growth.

2. The method according to claim 1, wherein the antimicrobial agent is present in an amount sufficient to provide the surface treatment composition with antimicrobial properties to resist spoilage.

3. The method according to claim 2 wherein the antimicrobial agent is present in an amount in the range of 0.002% to 3% by weight, based on total weight of the surface treatment composition.

4. The method according to claim 1, wherein the antimicrobial agent is present in an amount sufficient to provide the surface treatment composition with disinfectant properties at the surface.

5. The method according to claim 5, wherein the antimicrobial agent is present in an amount sufficient to cause a 5-log reduction in one or more target microorganisms at the surface in a time period of 1 minute or less.

6. The method according to claim 5 wherein the one or more target microorganisms are selected from Staphylococci spp., pseudomonads, Klebsiella spp., and coliforms.

7. The method according to claim 5 wherein the antimicrobial agent is present in an amount of 0.125% by weight or less, based on total weight of the surface treatment composition.

8. The method according to claim 1 wherein the surface treatment composition further includes a second antimicrobial agent.

9. The method according to claim 8 wherein the second antimicrobial agent is selected from phenol derivatives, dichlorophene, hexachlorophene, aldehydes, alcohols, antimicrobial carboxylic acids and derivatives thereof, organometallic compounds, iodine compounds, quaternary ammonium compounds, sulfonium and phosphonium compounds, mercapto compounds and the alkali metal, alkaline earth metal and heavy metal salts thereof, ureas, tribromosalicylanilide, 2-bromo-2-nitro-1,3-dihydroxypropane, dichlorobenzoxazolone, chlorohexidine, isothiazolone, benzisothiazolone derivatives and combinations of any two or more of these, with the following provisos: (a) phenol derivatives do not include BHT, BHA, TBHQ, tocopherols, cinnamic acid compounds, flavins or flavinoids; (b) antimicrobial carboxylic acids do not include lactic, acetic, citric, malic, succinic, natural amino acids, formic, propionic, butyric acids, and derivatives; (c) alcohols do not include C₁-C₄ alcohols.

10. The method according to claim 1 wherein the surface is a textile surface.

11. The method according to claim 1 wherein the surface is human skin, scalp, hair, eyes, mucous membranes, internal orifice or external orifice.

12. The method according to claim 1 wherein the surface treatment composition includes water as a solvent.

13. A method of treating a surface, the method comprising applying a surface treatment composition having a pH in the range of 4.1 to 8.5 to a surface, wherein the surface treatment composition includes a cleansing agent and an antimicrobial agent, the antimicrobial agent comprising 9-decenoic acid, a salt of 9-decenoic acid, an ester of 9-decenoic acid, or a combination thereof, wherein the antimicrobial agent is present in an amount sufficient to control microbial growth.

14. The method according to claim 13 wherein the surface treatment composition has a pH in the range of 6 to 8.

15. The method according to claim 13, wherein the antimicrobial agent is present in an amount sufficient to provide the surface treatment composition with antimicrobial properties to resist spoilage.

16. The method according to claim 15 wherein the antimicrobial agent is present in an amount in the range of 0.002% to 3% by weight, based on total weight of the surface treatment composition.

17. The method according to claim 13, wherein the antimicrobial agent is present in an amount sufficient to provide the surface treatment composition with disinfectant properties at the surface.

18. The method according to claim 17, wherein the antimicrobial agent is present in an amount sufficient to cause a 5-log reduction in one or more target microorganisms at the surface in a time period of 1 minute or less.

19. The method according to claim 13 wherein the antimicrobial agent is present in an amount of 0.125% by weight or less, based on total weight of the surface treatment composition.

20. A surface treatment composition comprising a substantially phenol-free cleansing agent and an antimicrobial agent, the antimicrobial agent comprising 9-decenoic acid, a salt of 9-decenoic acid, an ester of 9-decenoic acid, or a combination thereof, wherein the antimicrobial agent is present in an amount sufficient to control microbial growth.
